(19) United States
(12) Patent Application Publication
(10) Pub. No.: US 2026/0086972 A1
(43) Pub. Date: Mar. 26, 2026

(54) SENSOR SYSTEM WITH ASYNCHRONOUS DATA TRANSMISSION

(71) Applicant: Infineon Technologies AG, Neubiberg (DE)

(72) Inventors: Jakob VALTL, München (DE); Severin NEUNER, Valley (DE); Stephan LEISENHEIMER, Oberhaching (DE)

(21) Appl. No.: 19/335,714

(22) Filed: Sep. 22, 2025

(30) Foreign Application Priority Data
Sep. 24, 2024 (DE) 102024209147.2

(51) Int. Cl. G06F 13/42

(52) U.S. Cl. CPC G06F 13/4247

(57) ABSTRACT

The present disclosure relates to a sensor system with asynchronous data transmission, wherein the sensor system includes at least two individual sensors, each sensor having a first I/O pin and a second I/O pin. The sensor system also includes a microcontroller with a transmit pin and a receive pin, and a single-wire data line by means of which the microcontroller is configured to communicate with the individual sensors via an asynchronous data protocol. The single-wire data line runs between the transmit pin and the receive pin of the microcontroller, and the individual sensors are arranged in a daisy chain and are integrated into the single-wire data line in sequence.

### CROSS-REFERENCE TO RELATED APPLICATION

This application claims priority to Germany Patent Application No. 102024209147.2 filed on Sep. 24, 2024, the content of which is incorporated by reference herein in its entirety.

### TECHNICAL FIELD

The present disclosure relates to a sensor system with a microcontroller and at least two sensors, wherein the communication between the sensors takes place using an asynchronous data transmission on a single-wire data line. The concept presented here can represent, for example, an extension of the universal UART data protocol (UART: Universal Asynchronous Receiver Transmitter).

### BACKGROUND

In the case of electronic components, such as sensors, the technical trend today is towards ever-increasing miniaturization, which also means that the number of package pads available is becoming increasingly smaller. For example, sensor packages are produced that have only four package pads. One pad is provided for the supply voltage and one pad is connected to ground. This leaves only two pads as input/output (I/O) pads for data transfer. However, this causes problems as soon as multiple sensors within a sensor system need to communicate with each other.

One solution to this is the so-called Power Over Bus procedure. However, this requires expensive transmitters. Other existing solutions or bus systems require an initial initialization and/or addressing of the sensors so that they can communicate with each other. In order to reduce the complexity of bus systems, so-called single-wire communication systems are used, in particular in simple sensor systems, in which multiple sensors are connected to each other on the same single-wire line. Examples of this would be an Inter-Integrated Circuit (I²C) bus or a one-wire or single-wire bus.

These mostly bi-directional single-wire communication systems are usually based on open drain circuits with integrated pull-up resistors. However, this design leads to relatively slow baud rates of a maximum of approx. 115.4 kilobaud (kBd), which can quickly become critical, in particular in real-time sensor systems, such as ABS sensors. Open drain circuits with integrated pull-up resistors are also disadvantageous to the extent that the rising edge is flattened due to the inherent low-pass behavior, e.g., the signal quality at the rising edge is worse than, for example, in push-pull configurations.

Push-pull configurations would therefore be more preferred in this respect, since push-pull outputs are constantly driven (high or low) and thus offer better performance in terms of the edges of the generated digital output signals. However, in push-pull configurations, compared to open drain configurations, it is not possible to interconnect multiple devices in a single-wire bus topology. The push-pull configuration is therefore most commonly used for interfaces with unidirectional lines, e.g., data transmission on the single-wire line takes place only in one direction. Examples of this would be the SPI interface (Serial Peripheral Interface) or the UART interface (Universal Asynchronous Receiver Transmitter).

It would therefore be desirable to improve existing sensor systems so that multiple sensors can communicate with each other via a single-wire line without incurring the disadvantages that have just been discussed. In particular, it would be desirable to enable simple and cost-effective sensor communication on a single-wire data line without the need for prior initialization of the individual sensors, and with a significantly higher baud rate.

### SUMMARY

This can be implemented with a sensor system having asynchronous data transmission according to the innovative concept presented herein. The sensor system includes inter alia at least two individual sensors, each having a first I/O pin and a second I/O pin, as well as a microcontroller having a transmit pin (Tx) and a receive pin (Rx). The sensor system further includes a single-wire data line by means of which the microcontroller is configured to communicate with the individual sensors via an asynchronous data protocol. The single-wire data line runs between the transmit pin (Tx) and the receive pin (Rx) of the microcontroller. The individual sensors are arranged in a so-called daisy chain and integrated into the single-wire data line in sequence.

A person skilled in the art will discern further features and advantages of the implementation upon reading the following detailed description and examining the attached drawings.

### BRIEF DESCRIPTION OF THE DRAWINGS

The present disclosure is shown in an example and non-limiting manner in the illustrations of the attached drawings, in which identical reference numbers refer to similar or identical elements. The elements in the drawings are not necessarily depicted to scale in relation to each other. The features of the various examples shown can be combined, provided that they are not mutually exclusive.

FIG. 1 shows an example implementation of an innovative Daisy Chain Asynchronous Receiver Transmitter (DART) sensor system having a microcontroller and a plurality of sensors, which are interconnected in a daisy chain in a bi-directional line or series configuration,

FIG. 2 shows a further example implementation of an innovative DART sensor system having a microcontroller and a plurality of sensors, which are interconnected in a daisy chain in a bi-directional line or series configuration,

FIG. 3 shows a further example implementation of an innovative DART sensor system having a microcontroller and a plurality of sensors, which are interconnected in a daisy chain in a bi-directional line or series configuration,

FIG. 4 shows an example implementation of an innovative DART sensor system having a microcontroller and a plurality of sensors, which are interconnected in a daisy chain in a unidirectional line or series configuration,

FIG. 5 shows an example implementation of an innovative DART data frame with integrated synchronization pulses,

FIG. 6 shows a table which lists possible example implementations of commands that can be sent from the microcontroller to the DART sensors,

FIG. 7 shows an example implementation of a DART sensor and its internal hardware interconnection, which allows different states at the first and second I/O pins of the DART sensor,

FIG. 8 shows a schematic flowchart of an example implementation of a wake-up mode, and

FIG. 9 shows a schematic state diagram in which different possible states of the DART sensors are shown.

### DETAILED DESCRIPTION

The implementations described here enable a multi-sensor system having two or more sensors, which are configured to communicate with each other on a single-wire data line. An asynchronous data protocol can be used for communication. For example, the innovative asynchronous data protocol can be compatible with the existing UART standard. Existing UART interfaces also have single-wire data lines. However, these are simple point-to-point connections, with one controller connected to one sensor each. In the concept presented here, by contrast, a controller is connected to multiple sensors and is configured to communicate with these same sensors via the single-wire data line. For this purpose, the individual sensors are arranged in a so-called daisy chain and integrated into the single-wire data line in sequence. This means that the concept presented here, by analogy with UART (Universal Asynchronous Receiver Transmitter), can also be abbreviated to DART (Daisy Chain Asynchronous Receiver Transmitter).

The innovative DART concept presented here enables the provision of a multi-sensor network with different topologies or configurations for integrating two or more sensors into the single-wire data line. These may be, for example, ring configurations with a preferably unidirectional communication, wherein the data communication between the controller and the individual sensors takes place in one direction. Wake-up pulses or similar can also be sent in the opposite direction. Alternatively, the sensors can be integrated into the multisensor network in a simple line or row topology, wherein the sensors are integrated into the single-wire data line in a row, comparable to a chain of beads, and wherein the single-wire data line has an open end, preferably with a terminating resistor, after the last sensor. Communication between the controller and the sensors can be bi-directional, e.g., take place in both directions along the single-wire data line. The single-wire data line can consist of a single data wire. This can be used both for power supply and as a transmitting and receiving line. Since multiple sensors can be integrated into the single-wire data line, the DART sensor system presented here can also be referred to as a single-wire bus.

### DART in Line or Row Configuration

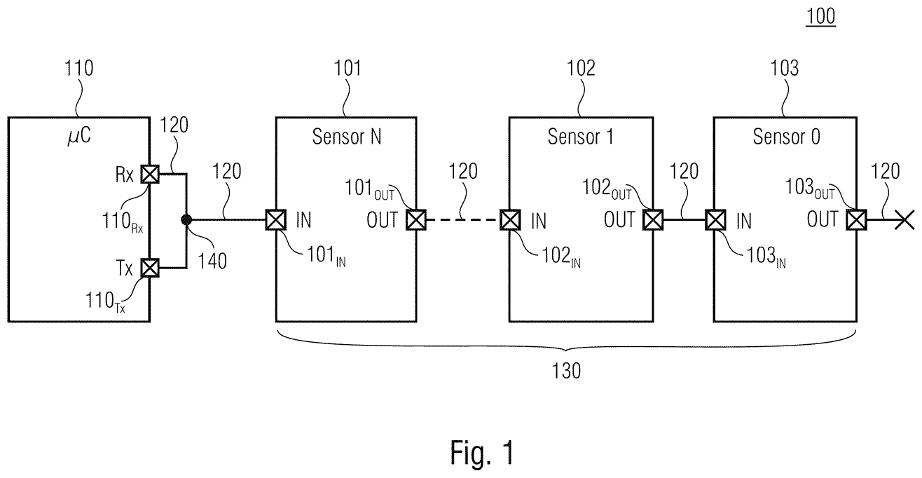

FIG. 1 shows a first example implementation of an innovative DART sensor system 100 with asynchronous data transmission. The sensor system 100 has at least two sensors 101, 102, each sensor 101, 102 having a first I/O pin 101_{IN}, 102_{IN} and a second I/O pin 101_{OUT}, 102_{OUT}. In a conceivable implementation, the sensors 101, 102 may each have exactly two I/O pins 101_{IN}, 102_{IN} and 101_{OUT}, 102_{OUT}. As a result, the sensors 101, 102 may be implemented in very simple and inexpensive hardware.

The sensor system 100 also has a control unit 110, e.g., in the form of a microcontroller. The microcontroller 110 has a transmit pin 110_{Tx} and a receive pin 110_{Rx}. In a conceivable implementation, the microcontroller 110 may have exactly one transmit pin 110_{Tx} and exactly one receive pin 110_{Rx}. This means that the microcontroller 110 may also be implemented in very simple and cost-effective hardware.

The sensor system 100 further comprises a single-wire data line 120, by means of which the microcontroller 110 may communicate (e.g., is configured to communicate) with the individual sensors 101, 102 via an asynchronous data protocol. The single-wire data line 120 runs between the transmit pin 110_{Tx} and the receive pin 110_{Rx} of the microcontroller 110, the individual sensors 101, 102 being arranged in a daisy chain 130 and integrated into the single-wire data line 120 in sequence.

In the example implementation shown in FIG. 1, the single-wire data line 120 has a node 140 between the transmit pin 110_{Tx} and the receive pin 110_{Rx} of the microcontroller 110. At this node 140, the single-wire data line 120 branches off and runs to the first sensor 101 in the daisy chain 130. The first sensor 101 in the daisy chain 130 is the sensor that is directly connected to the microcontroller 110.

The single-wire data line 120 is connected to the first I/O pin 101 IN of the first sensor 101 and thus connects the first sensor 101 to the previously mentioned node 140. In addition, the single-wire data line 120 is connected to the second I/O pin 101_{OUT} of the first sensor 101. The first sensor 101 has an internal circuit to internally forward the signals transmitted on the single-wire data line 120. This internal circuit is described in more detail below.

The single-wire data line 120 is connected to the second I/O pin 101_{OUT} of the first sensor 101 and to the first I/O pin 102_{IN} of the directly adjacent second sensor 102, thus connecting the first sensor 101 to the second sensor 102. In addition, the single-wire data line 120 is connected to the second I/O pin 102_{OUT} of the second sensor 102.

If further sensors, such as sensor 103, are present in the daisy chain 130, they are integrated into the daisy chain 130 in the manner described above with their respective first and second I/O pins.

The last sensor 103 in the daisy chain 130 is connected via its first I/O pin 103_{IN} to the directly adjacent penultimate sensor 102. The second I/O pin 103_{OUT} of the last sensor 103 may be configured as an uncontacted high-impedance floating output.

On the hardware side, in this implementation the transmit pin 110_{Tx} and the receive pin 110_{Rx} of the microcontroller 110 are thus interconnected, and the first sensor 101 in the daisy chain 130 is connected between the transmit pin 110_{Tx} and the receive pin 110_{Rx} of the microcontroller 110. One of the two I/O pins 103_{OUT} of the last sensor 103 in the daisy chain 130 is configured as an uncontacted high-impedance floating output.

The resulting line or row topology of the sensor system 100 allows bidirectional data communication to take place between the microcontroller 110 and the individual sensors 101, 102, 103 by means of the single-wire data line 120. The behavior of the sensors 101, 102, 103 and the microcontroller 110 in bidirectional data communication is explained in more detail below.

To enable bidirectional data communication on the single-wire data line 120, the transmit pin 110_{Tx} of the microcontroller 110 may have a push-pull tristate configuration. This will also be explained in more detail below.

If the transmit pin 110_{Tx} of the microcontroller 110 does not have a hardware-based push-pull tristate configuration, this may be retrofitted using an appropriate circuit.

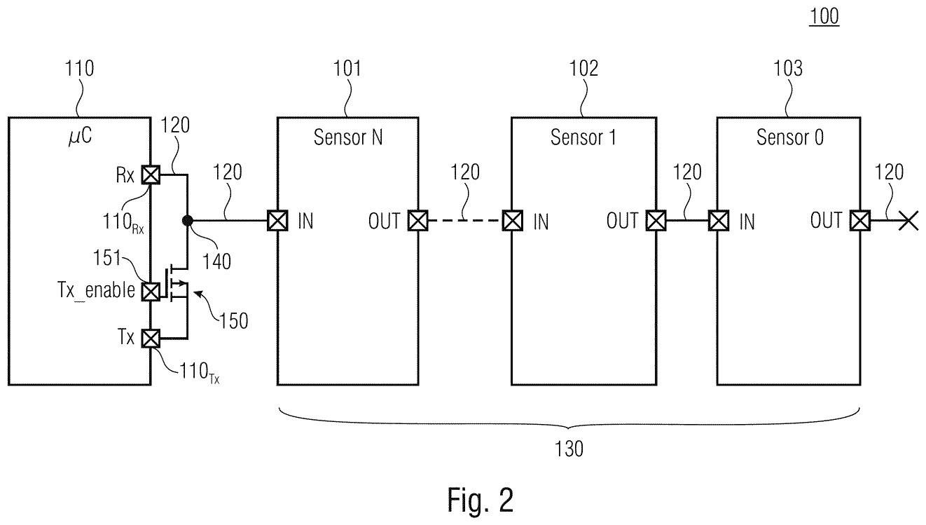

FIG. 2 shows a conceivable implementation of an innovative sensor system 100, in which the transmit pin 110_{Tx} of the microcontroller 110 has a push-pull configuration without a tristate state. Here, the microcontroller 110 can have a circuit 150 together with an additional enable pin 151 to implement a tristate state on the transmit pin 110_{Tx}. The circuit 150 may be integrated in the microcontroller 110, or may be connected externally between the node 140 and the transmit pin 110_{Tx}.

In the example implementation shown in FIG. 2, the transmit pin 110_{Tx} and the receive pin 110_{Rx} and the additional enable pin 151 of the microcontroller 110 are interconnected. The first sensor 101 in the daisy chain 130 can be connected between the receive pin 110_{Rx} and the additional enable pin 151 of the microcontroller 110. Since this again involves a line or row topology, similar to the example implementation shown in FIG. 1, one of the two I/O pins 103_{OUTOUT}f of the last sensor 103 in the daisy chain 130 can again be configured as an uncontacted high-impedance floating output.

The implementation of the innovative sensor system 100 illustrated in FIG. 2 thus also enables bidirectional data communication between the microcontroller 110 and the individual sensors 101, 102, 103 on the single-wire data line 120.

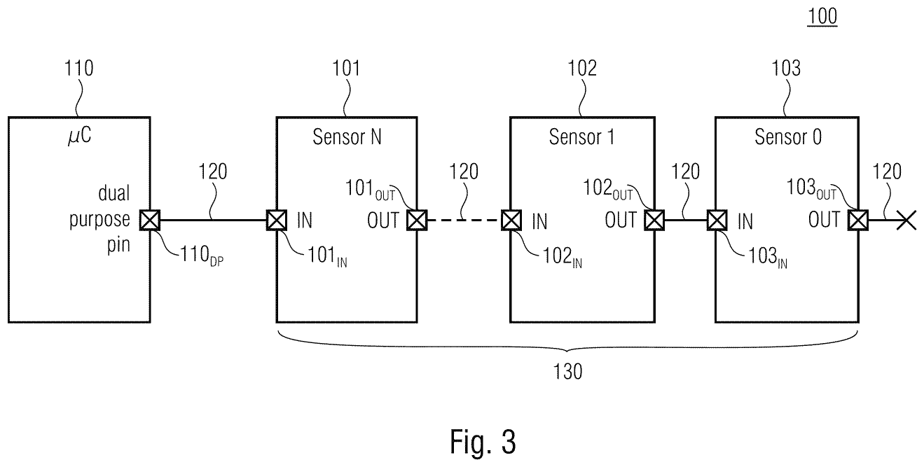

FIG. 3 shows another example implementation of an innovative sensor system 100 with a line or row topology and bi-directional communication on the single-wire data line 120. This implementation is substantially identical or similar to the previous implementations, except that the microcontroller 110 has only a single pin 110_{TD}, which is configured to be configured as a transmit pin and receive pin. Therefore, this pin 110_{TD} can also be referred to as a combined transmit and receive pin or as a dual-purpose pin. In one configuration, the microcontroller 110 has just this one dual-purpose pin 110_{TDF}, which means the microcontroller 110 can be implemented in a simple and inexpensive manner.

The sensor system 100 illustrated in FIG. 3 thus has at least two sensors 101, 102, 103, each sensor 101, 102, 103 having a first I/O pin 101_{IN}, 102_{IN}, 103_{IN} and a second I/O pin 101_{OUT}, 102_{OUT}, 103_{OUT}.

The sensor system 100 also has a microcontroller 110 with a combined transmit and receive pin 110_{DP}, which can be internally switched between a transmit state and a receive state.

The sensor system 100 also has a single-wire data line 120, by means of which the microcontroller 110 can communicate with the individual sensors 101, 102, 103 via an asynchronous data protocol, wherein the individual sensors 101, 102, 103 are arranged in a daisy chain 130 and are integrated into the single-wire data line 120 in sequence. The single-wire data line 120 runs between the combined transmit and receive pin 110_{DP} of the microcontroller 110 and the individual sensors 101, 102, 103 integrated in the daisy chain 130.

Here also, the sensor system 100 is configured to enable bi-directional data communication between the microcontroller 110 and the individual sensors 101, 102, 103 using the single-wire data line 120, wherein the first sensor 101 in the daisy chain 130 is connected to the combined transmit and receive pin 110_{DP} of the microcontroller 110, and one of the two I/O pins 103_{OUT} of the last sensor 103 in the daisy chain 130 is configured as an uncontacted high-impedance floating output.

### DART In Ring Configuration

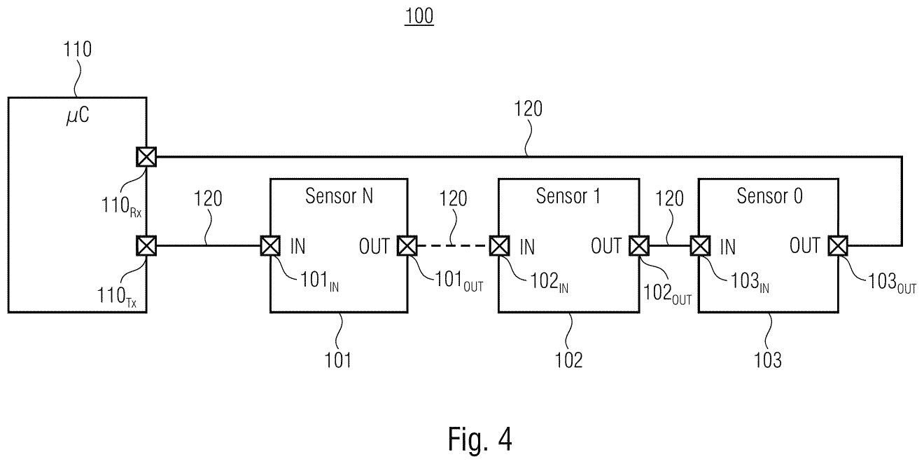

FIG. 4 shows an alternative implementation in which the sensor system 100 is configured to enable unidirectional data communication between the microcontroller 110 and the individual sensors 101, 102, 103 using the single-wire data line 120. In the context of the present disclosure, unidirectional data communication includes, among other things, the transmission of measurement data, commands and configuration data, in particular data that is encoded in one or more bytes. As will be further explained later, the sensor system 100 may have an autonomous wake-up mode in which wake-up pulses from individual sensors can be sent in both directions along the single-wire data line 120. Therefore, these wake-up pulses are not included in the unidirectional data communication within the scope of this disclosure.

As can be seen in FIG. 4, the sensor system 100 here has a ring configuration, wherein the first sensor 101 in the daisy chain 130 is connected in series with the transmit pin 110_{Tx} of the microcontroller 110 using the single-wire data line 120, and the last sensor 103 in the daisy chain 130 is connected in series with the receive pin 110_{Rx} of the microcontroller 110 using the single-wire data line 120. The individual sensors 101, 102, 103 within the daisy chain 130 are interconnected using the single-wire data line 120, as previously described with reference to the other implementations.

In all implementations, the individual sensors 101, 102 arranged within the daisy chain 130 can be directly connected to each other, e.g., there are no further components in the single-wire data line 120 extending between the individual sensors 101, 102.

### Pin Configurations of the Dart Microcontroller

In all implementations, the microcontroller 110 can send data, such as commands, via its transmit pin 110_{Tx} (or dual-purpose pin 110_{DP}) to the individual sensors 101, 102, 103. The sensors 101, 102, 103 in turn can send data, such as measurement results, to the microcontroller 110, which the latter can receive at its receive pin 110_{Rx} (or dual-purpose pin 110_{DP}).

For this purpose, the previously discussed implementations of the innovative sensor system 100 may differ from each other in terms of hardware. For example, the microcontroller 110 used in the line or row configuration with bi-directional communication (see FIGS. 1 to 3), as mentioned above, can have a transmit pin 110_{Tx} (or dual-purpose pin 110_{DP}), which in addition to a push-pull configuration has a tristate configuration or can be switched to a tristate state in order to receive data from the sensors 101, 102, 103.

According to such an example implementation, the microcontroller 110 can thus be configured to switch the transmit pin 110_{Tx} into a push-pull configuration before and during the transmission of data, in order to send a command via the single-wire data line 120 to at least one of the sensors 101, 102, 103 arranged in the daisy chain 130. In addition, the microcontroller 110 can be configured to switch the transmit pin 110_{Tx} into a tristate state before and during the reception of data from the individual sensors 101, 102, 103, in order to enable the single-wire data line 120 and to receive the data from the sensors (101, 102, 103) in sequence via the receive pin 110_{Rx}.

The microcontroller 110 which is used in the ring configuration according to FIG. 4 may, on the hardware side, have a transmit pin 110_{Tx} which only has a push-pull configuration, optionally without a tristate state. The receive pin 110_{Rx} of the microcontroller 110 can be configured in the ring configuration as an open-drain input with integrated pull-up resistor, which is why a tristate configuration or a tristate state of the transmit pin 110_{Tx} is not absolutely necessary here.

In all implementations described herein, in a portion of the single-wire data line 120 which runs between the microcontroller 110 and the first sensor 101 in the daisy chain 130, no external components, in particular no resistors, are arranged. In FIGS. 1 and 2, this would be, for example, the portion of the single-wire data line 120 which runs between the node 140 and the first sensor 101. In FIGS. 3 and 4, this would be the portion of the single-wire data line 120 that runs between the transmit pin 110_{Tx} or the transmit-receive pin 110_{DP}, and the first sensor 101. The absence of additional external components leads to a simplified and therefore cost-effective design, and also offers faster data transmission.

The innovative sensor system 100 can have different sensors 101, 102, 103. For example, the sensors 101, 102, 103 can be configured to perform magnetic field measurements, in particular 3D measurements in the x, y and z direction. Alternatively or in addition, sensors 101, 102, 103 can be configured to measure temperature, speed, acceleration, humidity and the like. The application areas of sensors 101, 102, 103 are not restricted to any specific functions. The sensors 101, 102, 103 can be equipped with a DART interface to allow them to be integrated into the innovative sensor system 100.

The sensors 101, 102, 103 can be used, for example, in the following applications:
Joystick,
Control elements (so-called white goods),
Multi-function buttons,
Intelligent door lock,
Smart home sensors,
E-meters,
IOT (Internet of Things) position and proximity sensor, and/or
Drones and robots

The sensors 101, 102, 103 can perform measurements. For example, a measurement can be initiated by the microcontroller 110 with a DART command. After the measurement is complete, the results are available in the bitmap of the respective sensor 101, 102, 103. The sensors 101, 102, 103 either wait for the microcontroller 110 to perform a readout if the sensors are in wake-up mode, or the sensors 101, 102, 103 report their measurements directly to microcontroller 110, depending on the configuration. If a sensor 101, 102, 103 is not communicating or measuring, it can remain in power-down mode.

### DART Data Frame and DART Commands

An innovative DART data frame can be used for communication between the microcontroller 110 and the sensors 101, 102, 103. For example, the DART data frame can be based on a UART data frame, making the innovative DART sensor system 100 compatible with the standardized UART protocol. Thus, existing UART sensors and UART controllers can be used in the DART sensor system 100 presented here.

In the DART sensor system 100 presented here, the default signal level can be set to high, as is the case with UART. The following description is based on this assumption. However, it would be equally conceivable for the default signal level of the innovative DART sensor system 100 to be low. In this case, the signal levels and states described below would of course be exactly reversed, but this is also covered by the following description.

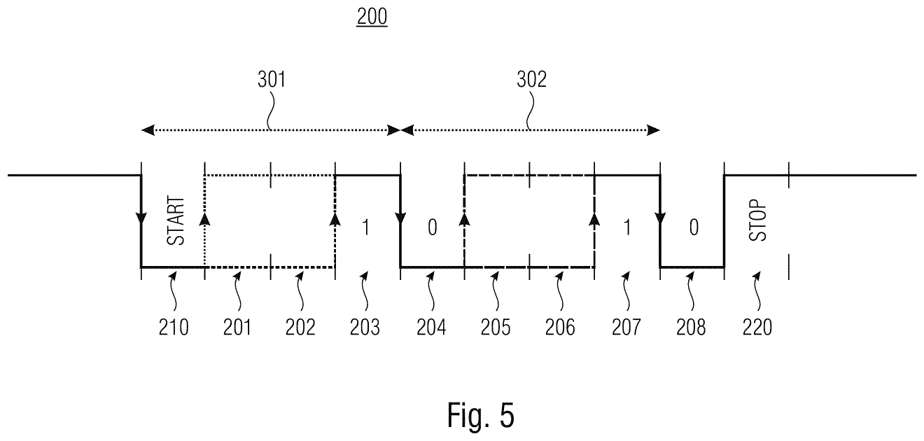

FIG. 5 schematically shows an example DART data frame 200. The data frame 200 has a start bit 210 and a stop bit 220 and at least eight intervening data bits 201, 202, . . . , 208. The first data bit 201 is the least significant bit (LSB). The last data bit 208 is the most significant bit (MSB). The data frame 200 can be used, for example, to send commands of the microcontroller 110 to one or more sensors 101, 102, 103. Alternatively or additionally, the data frame 200 can be used to send, for example, sensor data from one or more sensors 101, 102, 103 to the microcontroller 110.

According to one conceivable implementation, the microcontroller 110 may be configured to send one or more commands to one or more of the sensors 101, 102, 103 located in the daisy chain 120 via the single-wire data line 130. Each command can be encoded in a data frame 200.

For example, the microcontroller 110 can send a measurement command to the sensors 101, 102, 103. For example, the measurement command can be a broadcast measurement command that is sent to all sensors 101, 102, 103 in the daisy chain 130. The sensors 101, 102, 103 may or may not execute the measurement command of the microcontroller 110, depending on the configuration. For example, a measurement command to measure a temperature is executed only by temperature sensors, but not by acceleration sensors, even if the measurement command has been sent to all sensors 101, 102, 103 in the daisy chain 130.

The sensors 101, 102, 103 can respond to the measurement command by sending their measurement results to the microcontroller 110 in the form of sensor data encoded in a DART data frame 200. If the wake-up mode is activated, which will be described in more detail later, the sensor data can also be read with the same measurement command.

For example, the measurement command can be used to initiate a simultaneous measurement for all connected sensors 101, 102, 103. The measurement begins with the rising edge of the stop bit 220 of the measurement command. Upon completion of the measurement, each sensor 101, 102, 103 sends its released data bytes to the microcontroller 110, starting with the first sensor 101, which is directly connected to the microcontroller 110. The negotiation of the response sequence of the individual sensors 101, 102, 103 is described in more detail below.

Alternatively, or in addition to the measurement command, the microcontroller 110 can send a configuration command to the sensors 101, 102, 103. For example, the configuration command can be a broadcast configuration command that is sent to all sensors 101, 102, 103 in the daisy chain 130. The sensors 101, 102, 103 may or may not execute the configuration command of the microcontroller 110, depending on the hardware. For example, a configuration command to set a temperature range is executed only by temperature sensors, but not by acceleration sensors, even if the configuration command has been sent to all sensors 101, 102, 103 in the daisy chain 130.

For example, the configuration command can be used to configure all sensors 101, 102, 103 simultaneously. The configuration command is followed by the desired configuration. For example, for magnetic field sensors a desired magnetic measurement range could be set, for temperature sensors the temperature measurement could be enabled or disabled, and for sensors equipped with a power saving mode the power saving mode could be enabled or disabled.

Both the broadcast measurement command just described and the broadcast configuration command have the advantage that the individual sensors 101, 102, 103 within the daisy chain 130 do not necessarily need to be addressed, e.g., they can be integrated into the DART sensor system 100 and can communicate directly with the other bus subscribers in the DART sensor system 100. This increases the plug & play capability of the innovative DART sensor system 100.

### Auto-Addressing

Alternatively, or additionally, the sensors 101, 102, 103 can also be addressed individually. For this purpose, the microcontroller 110 may be configured to individually address individual sensors 101, 102, 103 within the daisy chain 130 first, in order to then send the respectively addressed sensors an individual measurement command and/or an individual configuration command. An individual measurement command can be used to signal to the addressed sensor to perform a measurement independently of the other sensors in the daisy chain 130. An individual configuration command can be used to individually configure the addressed sensor independently of the other sensors in the daisy chain 130.

In the innovative DART sensor system 100, each sensor can thus be configured or read out individually. One-time addressing can be performed before any individual communication. The addressed sensor remembers its address, assuming no power failure occurs.

A trigger addressing command sent by the microcontroller 110 can be answered consecutively by the sensors 101, 102, 103 in the daisy chain 130. The sensors 101, 102, 103 respond consecutively, starting with the first sensor 101, which is closest to the microcontroller 110. The responses sent by the sensors 102, 103, which are located further back in the daisy chain 130, are seen by the sensors located in between.

Each sensor increases its address for each response detected by another sensor located downstream in the daisy chain 130. The final state is that the first sensor 101 in the daisy chain 130, which is closest to the microcontroller 110, has the highest address, which at the same time also corresponds to the total number of sensors in the daisy chain 130.

For example, if there are eight sensors arranged in the daisy chain 130, then the last sensor in the daisy chain, which is furthest away from the microcontroller 110, assigns itself the address 00H. The subsequent sensors along the daisy chain in descending order in the direction of the microcontroller 110 increment their address according to the number of sensors present, so that the first sensor, which is arranged closest to the microcontroller 110, accordingly assigns itself the highest address 07H in this case.

According to such an implementation, the microcontroller 110 can be configured to carry out an auto-addressing operation before individually addressing a sensor 101, 102, 103, during which operation the sensors 101, 102, 103 in the daisy chain 130 assign themselves an individual address.

For this purpose, the microcontroller 110 can be configured to send an auto-addressing command to the sensors 101, 102, 103 arranged in the daisy chain 130 via the single-wire data line 120, wherein each sensor 101, 102, 103 has an integrated counter, the counter reading of which represents the individual address of the respective sensor 101, 102, 103, and wherein the individual sensors 101, 102, 103 respond to the auto-addressing command by the sensors 101, 102, 103 autonomously incrementing their counter readings.

The auto-addressing command can be processed by the sensors 101, 102, 103 in sequence by incrementing the counter value of a counter of each sensor 101, 102, 103 by one digit each depending on the number of sensors following it in the daisy chain 130, so that after the auto-addressing operation is completed, the first sensor 101 in the daisy chain 130 has the highest counter reading and the last sensor in the daisy chain 130 has the lowest counter reading.

The addressing sequence can also be reversed, however, so that the first sensor 101 in the daisy chain 130 has the lowest counter reading and the last sensor in the daisy chain 130 has the highest counter reading.

The microcontroller 110 can also count all sensor responses to confirm the number of sensors 101, 102, 103 in the daisy chain 130 and determine when the addressing operation is completed.

According to such an implementation, the microcontroller 110 can thus be configured to count the actual number of the sensors 101, 102, 103 self-addressed in response to the auto-addressing command and to compare it against a known target number of sensors in the daisy chain 130. The microcontroller 110 may be configured to send further commands and/or receive data only after the auto-addressing operation has terminated.

Thus, after the sensors 101, 102, 103 in the auto-addressing operation have assigned themselves an individual address, the microcontroller 110 can address the respective sensor individually via its corresponding address. For example, the microcontroller 110 can send an individual measurement command to an individual sensor. The individual measurement command is sent in a DART data frame 200, followed by another DART data frame 200 which contains the individual address of the sensor to be addressed. The individually addressed sensor responds to this with its sensor measurement data, which is also sent to the microcontroller 110 in a DART data frame 200.

Alternatively, or additionally, the microcontroller 110 can individually address a single sensor via its corresponding address after an auto-addressing operation in order to configure it. For example, the microcontroller 110 can send an individual configuration command to an individual sensor. The individual configuration command is sent in a DART data frame 200, followed by a second DART data frame 200 which contains the individual address of the sensor to be addressed. This is followed in turn by a third DART data frame 200 containing the desired configuration of the individually addressed sensor.

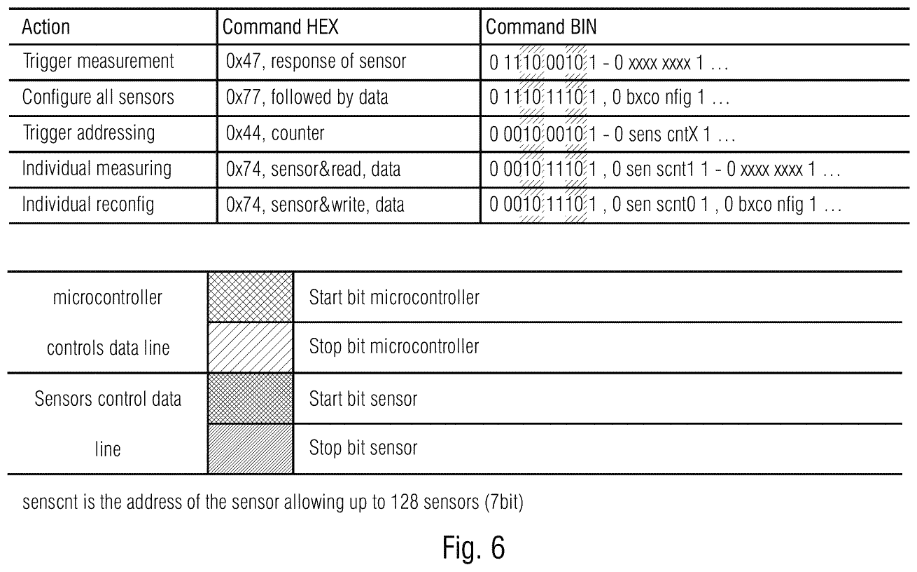

FIG. 6 shows a possible implementation of the actions described above, which can be carried out by the microcontroller 110 or by the sensors 101, 102, 103. These actions are listed in the left-hand column of the table shown in FIG. 6. The central column shows the commands in the hexadecimal system. The right-hand column lists the command bins.

For example, the first row shows the previously discussed broadcast measurement command “Trigger a measurement”, which here is encoded with the hex code 0x47. This corresponds to the binary sequence (without start bit 0 and stop bit 1) 1110 0010 in the DART data frame 200. In response to this, a response is expected from all sensors in the form of sensor measurement data. Since the sensor measurement data in the DART data frame 200 can be of arbitrary form, this is specified in the third column with the value xxxx xxxx between the start bit 0 and stop bit 1.

The second row shows the previously discussed broadcast configuration command “Configure all sensors”, which here is encoded with the hex code 0x77. This corresponds to the binary sequence (without start bit 0 and stop bit 1) 1110 1110 in the DART data frame 200. Directly thereafter, another DART data frame 200 is sent, which contains the desired configuration. The configurations in the third column are given, purely as examples, with the value bxco nfig between the start bit 0 and stop bit 1.

The third row shows the previously discussed auto-addressing command “Trigger addressing”, which here is encoded with the hex code 0x44. This corresponds to the binary sequence (without start bit 0 and stop bit 1) 0010 0010 in the DART data frame 200. In response to this, a response is expected from the sensors in the form of their self-assigned addresses. The addresses returned to the microcontroller 110 in the DART data frames 200 given in the third column as examples are shown with the value sens cntX between the start bit 0 and stop bit 1. In this example, the addresses are encoded with 7 bits, which allows up to a total of 128 individually addressed sensors in the DART sensor system 100.

The fourth row shows the previously discussed individual measurement command “Individual measuring”, which can be sent after the auto-addressing and which is encoded here with the hex code 0x74. This corresponds to the binary sequence (without start bit 0 and stop bit 1) 0010 1110 in the DART data frame 200. The fifth row shows the previously discussed individual configuration command “Individual reconfig”, which can be sent after the auto-addressing and which is encoded here with the hex code 0x74. This corresponds to the binary sequence (without start bit 0 and stop bit 1) 0010 1110 in the DART data frame 200.

Since the individual measurement command “Individual measuring” and the individual configuration command “Individual reconfig” are quite similar in structure, both will be described together in the following.

The first byte 0x74 in data frame 200 thus initially indicates individual communication. The second byte then has a similar structure to the command byte of the I²C standard and contains the following information:
if an individual measurement is triggered which is followed by a sensor response, then the MSB is 1_{B} (see “sen scnt1”) followed by the individual 7-bit address, with the sensor furthest away from the microcontroller 110 having address 00H, or
if an individual configuration of a sensor is triggered, then the MSB is 0_{B} (see “sen scnt0”) followed by the individual 7-bit address, with the sensor furthest away from the microcontroller 110 having address 00H.

When triggering the individual measurement command, a response is expected from the individually addressed sensor in the form of sensor measurement data, which is sent to the microcontroller 110 in a DART data frame 200. This data is shown here by way of example with the value xxxx xxxx between the start bit 0 and stop bit 1.

When the individual configuration command is triggered, a third DART frame 200 is sent from the microcontroller 110 to the individually addressed sensor containing the desired configuration. This data is shown here purely by way of example with the value bxconfig between the start bit 0 and stop bit 1.

Individual sensor communication should not be used if one of the sensors 101, 102, 103 in the daisy chain 130 is in the wake-up mode. For an individual measurement/configuration, the auto-addressing must also have been carried out beforehand.

The individual readout of the sensors and the individual configuration is the same for all sensors 101, 102, 103 in the daisy chain 130. After an individual sensor communication, the microcontroller 110 can wait for a time T_{time_out_delay} before sending the next command.

### Self-Synchronization and Variable Data Rate

Another advantage of the innovative DART sensor system 100 is that it can be self-synchronizing. A DART data frame 200 may contain at least one synchronization pulse for this purpose, which encodes the current clock rate or bit rate or baud rate, which means that a receiver of the DART data frame 200 receives the current bit rate or baud rate directly on the readout or decoding of the received DART data frame 200 and can set itself to this bit or baud rate. This eliminates the need for a high-precision and expensive internal clock generator. Instead, relatively simple and inexpensive clock generators can be used, so that the microcontroller 110 in particular can be further simplified and cost-effective.

The synchronization pulse moreover enables the microcontroller 110 to change its current bit or baud rate, theoretically with each individual DART data frame 200. As mentioned above, conventional single-wire communication systems up to now have usually been based on open-drain circuits with integrated pull-up resistors. However, due to their design, these have relatively slow baud rates of up to a maximum of approx. 115.4 kBd. Since the innovative DART sensor system 100 uses push-pull configurations that can be continuously driven (high or low) and thus offer better performance, the bit or baud rate can be increased to up to 8,000 kBd, and in particularly advantageous configurations even up to 40 megabaud (MBd). The microcontroller 110 can therefore be configured to transmit a data frame 200 with a variable baud rate of 100 kBd up to 40,000 kBd on the single-wire data line 120.

FIG. 5 shows one of several possible implementations in which the at least one synchronization pulse can be integrated into the DART data frame 200. In the non-limiting example implementation shown here, two synchronization pulses 301, 302 are integrated in the DART data frame 200. However, a single synchronization pulse is also conceivable. The synchronization pulses 301, 302 define the time interval between two identical edge changes, in the example shown here the edge changes from high to low. A single synchronization pulse 301, 302 is thus characterized by two edge changes in the same direction, spaced apart by a fixed amount.

In the non-limiting example shown in FIG. 5, the edge changes between the third data bit 203 and the fourth data bit 204 and between the seventh data bit 207 and the eighth data bit 208 are inserted. Thus, the sensors 101, 102, 103 here always see, regardless of the action that is carried out on the DART interface, two synchronization pulses 301, 302 of fixed length (three falling edges) in order to adopt the baud rate selected by the microcontroller 110.

The user data contained in the DART data frame 200 is arranged between the respective synchronization pulse 301, 302. The user data can be, as described above, commands of microcontroller 110, for example.

In fact this can also be seen in FIG. 6, where the commands are shown in the third column of the table. Here it can be seen that for each command an edge change from high (‘1’) to low (‘0’) takes place between the third and fourth bit and between the seventh and eighth bit. These are the previously described edge changes that identify the at least one synchronization pulse 301, 302.

As can be seen, the synchronization pulses (edge change 1->0) are present at the same position for all commands. Thus, the different commands are primarily transmitted in the intervening bits or in the high-low time information of the synchronization pulses 301, 302. In other words, the ratio of the period of time between a low signal level and a high signal level of a synchronization pulse 301, 302 encodes the respective command which the microcontroller 110 sends to the sensors 101, 102, 103 arranged in the daisy chain 130.

According to such an implementation, the microcontroller 110 can thus be configured to integrate at least one synchronization pulse 301, 302 in the data frame 200, which indicates the currently selected bit or baud rate. The sensors 101, 102, 103 arranged in the daisy chain 130 are therefore configured to determine the bit rate or baud rate selected by the microcontroller 110 using the synchronization pulse 301, 302 integrated in the data frame 200 in order to synchronize with the microcontroller 110.

As mentioned earlier, the microcontroller 110 can send different commands (see, among others, FIG. 6 and associated description) to the sensors 101, 102, 103 integrated in the daisy chain 130. In particular, in bidirectional communication, such as can be used, for example, in the example implementations discussed with reference to FIGS. 1 to 3, a response sequence must be specified which prescribes the order in which the individual sensors 101, 102, 103 send their respective measurement results (sensor data) to the microcontroller 110, so that collisions can be avoided on the single-wire data line 120.

### DART Sensors-Hardware Circuit

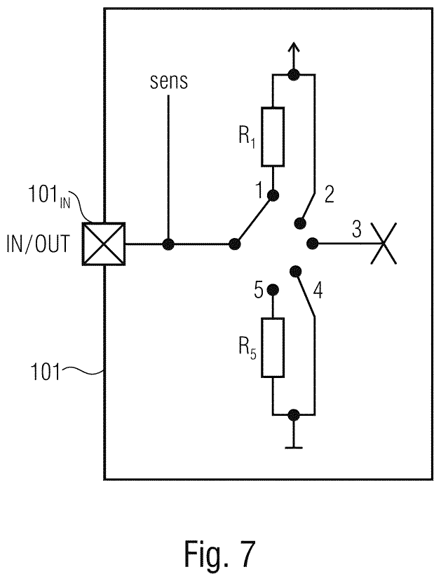

Another advantage of the innovative concept presented here is that the sensors 101, 102, 103 can negotiate a response sequence themselves. The “intelligence” does not have to be integrated into the microcontroller 110, which in turn is conducive to using a simple and inexpensive microcontroller 110. Instead, the “intelligence” is shifted into the sensors 101, 102, 103 themselves. This in turn is made possible by the special hardware-side structure of the sensors 101, 102, 103, which is to be briefly explained below with reference to FIG. 7.

FIG. 7 shows a purely schematic view of a DART sensor 101, as can be used in the DART sensor system 100 presented here. The following description also applies to all DART sensors 101, 102, 103. Five different pin configurations are shown within the sensor 101, which can be implemented in hardware. All five variants are first described below. However, a DART sensor 101, 102, 103 does not necessarily have to have all five configurations.

First of all, it must be noted that the first I/O pin 101_{IN} of the sensor 101 can be used both as an input pin and as an output pin, in particular in row or series topologies with bidirectional communication. In addition, as an example only the first I/O pin 101_{IN} of sensor 101 is shown here. However, this section of the description applies equally to the second I/O pin 101_{OUT} of sensor 101 (not shown here).

The I/O pins 101_{IN}, 101_{OUT} of the sensor 101 can have multiple states (e.g., a plurality of states), where not all states are required for both the respective IO pin 101_{IN}, 101_{OUT}. The required states depend, among other things, on the application case or also on the selected topology, e.g., line or row topologies with bi-directional communication (FIGS. 1 to 3) or ring topology (FIG. 4).

Initially, the I/O pins 101_{IN}, 101_{OUT} are always able to receive a signal, otherwise the following states are possible:
1. Pull-up: the I/O pin 101_{IN} is pulled high via a resistor. The default sense level is high and can only be (e.g., is capable of being) reduced by an external connection to ground. (Receive when sending a character)
2. Push-pull high: the I/O pin 101_{IN} is high and can also pull a connected component to high. (Send)
3. Tri-State: the I/O pin 101_{IN} is “floating”, has a high impedance and varies according to the level of the connected component. (Receive)
4. Push-pull low: the I/O pin 101_{IN} is low and can also pull a connected component to low. (Send)
5. Pull-down: the I/O pin 101_{IN} is pulled low via a resistor. The default sense level is low and can only be raised by an external connection to supply potential VCC. (Receive while sending a character)

After the hardware design of the sensors 101, 102, 103 has been discussed, different application cases will be described below, which the sensors 101, 102, 103 can implement independently. The above-mentioned application case of the independent negotiation of the response sequence for transmitting measurement results (sensor data) to the microcontroller 110 is discussed first. This is used both in line or row topologies with bidirectional communication, as shown in FIGS. 1 to 3, and also in ring configurations with unidirectional communication, as shown in FIG. 4.

### Negotiating the Response Sequence of the DART Sensors in the Line or Row Configuration

Firstly, the negotiation of the response sequence in line or row topologies according to FIGS. 1 to 3 is discussed. Then the negotiation of the response sequence in a ring topology according to FIG. 4 will be discussed

According to one implementation, the sensors 101, 102, 103 arranged in the line or row configuration are configured to transmit their measurement data to the microcontroller 110 in ascending response order, starting with the sensor 101 positioned closest to the microcontroller 110 (based on the connection sequence in the daisy chain 130) through to the sensor 103 positioned farthest away from the microcontroller 110.

To negotiate the response sequence, the sensors 101, 102, 103 carry out the following steps after receiving a command from microcontroller 110 that requires a sensor response (e.g., measurement results):
after receiving a measurement command (see e.g., FIGS. 6, 0x47_{H} “Trigger measurement”) from the microcontroller 110, the sensors 101, 102, 103 set their first I/O pins 101_{IN}, 102_{IN}, 103_{IN} (see FIGS. 1 to 3) to the above described state 1 (pull-up) and their second I/O pin 101_{OUT}, 102_{OUT}, 103_{OUT} to the above described state 4 (push-pull low).

As soon as a sensor (e.g., sensor 102) arranged at position X in the daisy chain 130 detects a high level at its first I/O pin 102_{IN} (e.g., initiated via the receive pin 110_{Rx} of the microcontroller 110 (pull-up of the sensors) or by a preceding sensor 101), the sensor 102, located at position X, knows that it is its turn to transmit its sensor data. To transmit the sensor data, it toggles its first I/O pin 102_{IN} between the states 2 (push-pull high) and 4 (push-pull low), while its second I/O pin 102_{OUT} remains in state 4 (push-pull low).

Thus, the sensors 101, 102, 103 are configured to switch their first I/O pin 101_{IN}, 102_{IN}, 103_{IN} to the pull-up state and their second I/O pin 101_{OUT}, 102_{OUT}, 103_{OUT} to the push-pull low state after receiving the measurement command, wherein a sensor 102 arranged at position X in the daisy chain 130 (e.g., a first sensor) sends its measurement data in the direction of the microcontroller 110 only when it receives a high signal level at its first I/O pin 102_{IN}, the high signal level coming either from a sensor 101 directly adjacent to the microcontroller 110 (e.g., an adjacent sensor, a second sensor, or a first adjacent sensor adjacent to sensor 102 arranged at position X), or from the microcontroller 110 itself. The sensor 102 arranged at position X is also configured to toggle (e.g., switch back and forth) its first I/O pin 102_{IN} between the push-pull high state and the push-pull low state to transmit its measurement data, while its second I/O pin (102_{OUT}) remains in the push-pull low state.

When the sensor 102 located at position X has finished its data output, it sets its second I/O pin 102_{OUT} to state 1 (pull-up) and its first I/O pin 102_{IN} to state 1 (pull-up) also. As a result, other sensors 103 located further down in the single-wire data line 130 know that it is now their turn to communicate and send their sensor data (measurement results).

The sensor 102 arranged at position X can thus be configured to switch both its first I/O pin 102_{IN} and its second I/O pin 102_{OUTOUT} to the pull-up state after a completed transmission of measurement data in order to signal to a sensor 103, directly adjacent in the opposite direction of the microcontroller 110 (e.g., an oppositely-adjacent sensor being opposite relative to adjacent sensor 101, a third sensor, or a second adjacent sensor adjacent to sensor 102 arranged at position X), using a high signal level that it is now the turn of this adjacent sensor 103 to send its measurement results in the form of sensor data encoded in a DART data frame 200.

The sensor 102 arranged at position X can now forward the sensor data received from the adjacent sensor 103 in the direction of the microcontroller 110. In doing so, the sensor 102 arranged at position X can first detect a low pulse at its second I/O pin 102_{OUT}, which comes from the adjacent sensor 103, even if its second I/O pin 102_{OUT} remains in state 1 (pull-up).

The low pulses, which contain the sensor data of the adjacent sensor 103, are sent or forwarded to the microcontroller 110 by setting the first I/O pin 102_{IN} of the sensor 102 arranged at position X to the state 4 (push-pull low) for the duration of the received low pulse. After the low pulse has terminated, the state of the first I/O pin 102_{IN} of the sensor 102 arranged at position X automatically switches back to state 1 (pull-up), since the signal level on the single-wire data line 120 is set to high by default.

This means that the sensor data of the adjacent sensor 103 is received by the sensor 102 arranged at position X at its second I/O pin 102_{OUT} and is forwarded internally to its first I/O pin 102_{IN} in order to transmit the sensor data of the adjacent sensor 103 to the microcontroller 110. The sensor data received at the second I/O pin 102_{OUT} is thus mirrored at the first I/O pin 102_{IN}.

Thus, if the sensor 102 arranged at position X receives a high signal level from the adjacent sensor 103 at its second I/O pin 102_{OUT} (for the duration of the reception of the sensor data of the adjacent sensor 103), then it must also output this high signal level at its first I/O pin 102_{IN}. On the other hand, if the sensor 102 arranged at position X receives a low signal level from the adjacent sensor 103 at its second I/O pin 102_{OUT} (for the duration of the reception of the sensor data of the adjacent sensor 103), it must also output this low signal level at its first I/O pin 102_{IN}.

The sensor 102 arranged at position X can therefore be configured to forward sensor data (or measurement results or measurement data) of the adjacent sensor 103 along the daisy chain 130 in the direction of the microcontroller 110 by mirroring at its first I/O pin 102_{IN} the signal level received from the adjacent sensor 103 at its second I/O pin 102_{OUT} during the reception of the measurement data.

For this purpose, the sensor 102 arranged at position X may be configured to switch its first I/O pin 102_{IN} to the push-pull low state (state 4) during the reception of the sensor data of the adjacent sensor 103 for the duration of a received low signal level, and to switch its first I/O pin 102_{IN} to the push-pull high (state 2) or back to the pull-up state (state 1) for the duration of a received high signal level.

The microcontroller 110 knows when no more sensor data is received and can then send a new command. The microcontroller 110 can therefore be configured to wait for the complete receipt of the measurement data from the sensors 101, 102, 103 arranged in the daisy chain 130 before the microcontroller 110 sends another command to the sensors 101, 102, 103.

As mentioned earlier, the sensor 102 arranged at position X may be configured to transfer the measurement data received from the adjacent sensor 103 internally between its first and second I/O pins 102_{IN}, 102_{OUT}, in order to forward the measurement data received from the adjacent sensor 103 in the direction of the microcontroller 110.

Instead of the digital data forwarding, which starts from an information pulse or the actual data transmission, the internal forwarding of the signal can also be realized with the aid of buffers or analog signal paths. Accordingly, the sensor 102 arranged at position X may, for example, have an integrated digital buffer circuit in order to forward the measurement data in digital form between the pins 102_{IN}, 102_{OUT}. Alternatively or additionally, the sensor 102 arranged at position X may have an integrated impedance transformer to forward the measurement data in analog form between pins 102_{IN}, 102_{OUT}.

In summary, the innovative DART sensors 101, 102, 103 can thus be configured to switch their first and second I/O pins 101_{IN}, 101_{OUT}, 102_{IN}, 102_{OUT}, 103_{IN}, 103_{OUT} to at least the following states in order to independently negotiate the response sequence in a line or row configuration:
First I/O pin 101_{IN}, 102_{IN}, 103_{IN}: States 1, 2 and 4
Second I/O pin 101_{OUT}, 102_{OUT}, 103_{OUT}: States 1, 2 and 4

### Negotiating the Response Sequence of the DART Sensors in the Ring Configuration

The implementations described so far related to the negotiation of the response sequence of the sensors 101, 102, 103 in a line or row configuration as shown in FIGS. 1 to 3. The following text discusses the concept of negotiating the response sequence of the sensors 101, 102, 103 in a ring configuration as shown in FIG. 4. The ring configuration can include unidirectional communication. However, bidirectional communication, at least between the sensors 101, 102, 103, would also be conceivable here.

According to one example implementation, the sensors 101, 102, 103 arranged in the ring configuration are configured to transmit their measurement data to the microcontroller 110 in descending response order, starting with the sensor 101 positioned closest to the receive pin 110_{Rx} of the microcontroller 110 (with respect to the connection sequence in the daisy chain 130), through to the sensor 103 positioned closest to the transmit pin 110_{Tx} of the microcontroller 110.

To negotiate the response sequence, the sensors 101, 102, 103 arranged in the ring configuration according to FIG. 4 carry out the following steps after receiving a command from the microcontroller 110 that requires a sensor response (e.g., measurement results):

After receiving a measurement command (see e.g., FIGS. 6, 0x47_{H} “Trigger measurement”) from the microcontroller 110, the sensors 101, 102, 102 set their first I/O pin 101_{ININ}, 102_{ININ}, 103_{ININ} (see FIG. 4) to the above described state 5 (pull-down) and its second I/O pin 101_{OUT}, 102_{OUT}, 103_{OUT} to the above described state 1 (pull-up), wherein the pull-up resistor can be many times larger than the pull-down resistance.

The sensors 101, 102, 103 arranged in the daisy chain 130 can therefore be configured to switch their first I/O pin 101_{IN}, 102_{IN}, 103_{IN} to the pull-down state and to switch their second I/O pin 101_{OUT}, 102_{OUT}, 103_{OUT} to the pull-up state after receiving the measurement command, wherein the pull-up resistor should be larger than the pull-down resistor by at least as much as needed to pull a value generated in the resistor divider to a defined signal level.

If the sensor 101 positioned closest to the transmit pin 110_{Tx} of the microcontroller 110 detects a high signal level at its first I/O pin 101_{IN}, then this sensor 101 knows that it is the last one in the response sequence and switches its first I/O pin 101_{IN} to state 3 (tri-state).

As soon as a sensor arranged at position X, for example sensor 102, detects a high signal level at its second I/O pin 102_{OUT}, the sensor 102 arranged at position X knows that it is now in its turn to transmit its measurement data. For this purpose the sensor 102 arranged at position X can toggle (e.g., switch back and forth) its second I/O pin 102_{OUT} between the states 2 (push-pull High) and 4 (push-pull Low), while its first I/O pin 102_{IN} remains in state 5 (pull-down).

When the sensor 102 located at position X has finished its data output, it sets its first I/O pin 102_{IN} to state 3 (tri-state) and its second I/O pin 102_{OUT} to state 2 (pull-up). Sensors with a lower address then know that it is now their turn to communicate and send their data.

Accordingly, the sensor 102 arranged at position X can be configured to switch its first I/O pin 102_{IN} to the tristate state after a completed transmission of its measurement data, in order to signal to a sensor 101, directly adjacent in the direction of the transmission pin 110_{Tx} of the microcontroller 110, using a high signal level that it is the next sensor in the response sequence to transmit its measurement data. The adjacent sensor 101 may in turn be configured to transmit its measurement data in the form of sensor data encoded in a DART data frame 200 in response to the received high signal level.

The sensor 102 arranged at position X can now forward the sensor data received from the adjacent sensor 101 in the direction of the receive pin 110_{Rx} of the microcontroller 110. In doing so, the sensor 102 arranged at position X can first detect a low pulse at its first I/O pin 102_{IN}, which comes from the adjacent sensor 101, even if its first I/O pin 102_{IN} remains in state 3 (tristate).

A low pulse coming from a sensor 101 on the left side (positioned closer to the receive pin 110_{Rx} of the microcontroller 110) is detected by the sensor 102 located at position X at its first I/O pin 102_{IN}. The low pulses containing the sensor data of the other sensor 101 are sent to the receive pin 110_{Rx} of the microcontroller 110 by the sensor 102 arranged at position X setting its second I/O pin 102_{OUT} to state 4 (push-pull low) during the time of the received low pulse. After the low pulse has terminated, the state of the second I/O pin 102_{OUT} changes back to 2 (push-pull high).

The low pulses containing the sensor data of the adjacent sensor 101 are thus sent or forwarded to the receive pin 110_{Rx} of the microcontroller 110 by setting the second I/O pin 102_{OUT} of the sensor 102 arranged at position X to state 4 (push-pull low) for the duration of the received low pulse. After the low pulse has terminated, the state of the first I/O pin 102_{OUT} of the sensor 102 arranged at position X automatically switches back to state 2 (push-pull high), since the signal level on the single-wire data line 120 is set to high by default.

This means that the sensor data of the adjacent sensor 101 is received by the sensor 102 arranged at position X at its first I/O pin 102_{IN} and is forwarded internally to its first I/O pin 102_{OUT} in order to transmit the sensor data of the adjacent sensor 101 to the microcontroller 110. The sensor data received at the first I/O pin 102_{IN} is thus mirrored at the second I/O pin 102_{OUT}.

Thus, if the sensor 102 arranged at position X receives a high signal level from the adjacent sensor 101 at its first I/O pin 102_{IN} (for the duration of the reception of the sensor data of the adjacent sensor 101), then it must also output this high signal level at its second I/O pin 102_{OUT}. On the other hand, if the sensor 102 arranged at position X receives a low signal level from the adjacent sensor 101 at its first I/O pin 102_{IN} (for the duration of the reception of the sensor data of the adjacent sensor 101), it must also output this low signal level at its second I/O pin 102_{OUT}.

The sensor 102 arranged at position X can therefore be configured to forward sensor data (e.g., measurement results or measurement data) of the adjacent sensor 101 along the daisy chain 130 in the direction of the microcontroller 110 by mirroring at its second I/O pin 102_{OUT} the signal level received from the adjacent sensor 101 at its first I/O pin 102_{IN} during the reception of the measurement data.

For this purpose, the sensor 102 arranged at position X may be configured to switch its second I/O pin 102_{OUT} to the push-pull low state (state 4) during the reception of the sensor data of the adjacent sensor 101 for the duration of a received low signal level, and to switch its second I/O pin 102_{OUT} to the push-pull high (state 2) or back to the pull-up state (state 1) for the duration of a received high signal level.

The microcontroller 110 knows when no more sensor data is received and can then send a new command. The microcontroller 110 can therefore be configured to wait for the complete receipt of the measurement data from the sensors 101, 102, 103 arranged in the daisy chain 130 before the microcontroller 110 sends another command to the sensors 101, 102, 103.

As mentioned earlier, the sensor 102 arranged at position X may be configured to transfer the measurement data received from the adjacent sensor 101 internally between its first and second I/O pins 102_{IN}, 102_{OUT}, in order to forward the measurement data received from the adjacent sensor 101 in the direction of the microcontroller 110.

Instead of the digital data forwarding, which starts from an information pulse or the actual data transmission, the internal forwarding of the signal can also be realized with the aid of buffers or analog signal paths. Accordingly, the sensor 102 arranged at position X may, for example, have an integrated digital buffer circuit in order to forward the measurement data in digital form between the pins 102_{IN}, 102_{OUT}. Alternatively or additionally, the sensor 102 arranged at position X may have an integrated impedance transformer to forward the measurement data in analog form between pins 102_{IN}, 102_{OUT}.

In summary, the innovative DART sensors 101, 102, 103 can thus be configured to switch their first and second I/O pins 101_{IN}, 101_{OUT}, 102_{IN}, 102_{OUT}, 103_{IN}, 103_{OUT} to at least the following states in order to independently negotiate the response sequence in a ring configuration:
First I/O pin 101_{IN}, 102_{IN}, 103_{IN}: States 3 and 5
Second I/O pin 101_{OUT}, 102_{OUT}, 103_{OUT}: States 1, 2 and 4

The example implementations described above related to the fact that the microcontroller 110 has sent a measurement command to the sensors 101, 102, 103, whereupon the sensors 101, 102, 103 have transmitted their respective sensor data (measurement results) to the microcontroller 110. This means that here a measurement was triggered by the microcontroller 110 with the measurement command.

### Wake-Up Mode

In a further configuration of the innovative DART sensor system 100, a measurement can also be triggered by a sensor 101, 102, 103 itself if the wake-up function is activated.

This means that the DART sensors 101, 102, 103 can be configured in a wake-up mode, which will be described in more detail below.

For example, it is conceivable that one or more sensors 101, 102, 103 are operated in the wake-up mode. The sensors 101, 102, 103 configured in wake-up mode carry out regular measurements without the control or explicit measurement commands of the microcontroller 110. Instead, the sensors 101, 102, 103 independently transmit a wake-up signal to the microcontroller 110 if predefined measurement values are exceeded.

The sensors 101, 102, 103 can wake up periodically, wherein the cycle (e.g., every ˜0.8 s) can be individually configured. The configuration can be carried out, for example, using the broadcast configuration command described above or using the individually addressed configuration command. Alternatively or in addition, a threshold measurement value can be defined, which is also freely configurable. The threshold measurement value can be adjusted for one or more sensors 101, 102, 103 and can be set, for example, using the broadcast configuration command described above or using the individually addressed configuration command. Alternatively, a threshold measurement range can be specified instead of the threshold measurement value.

If a signal measured by a sensor 101, 102, 103 is outside the configured threshold measurement value or outside the configured threshold measurement range, the respective sensor 101, 102, 103 can send a wake-up signal to the microcontroller 110. The corresponding sensor as well as the other sensors remain awake, store their last measurement results and wait for them to be read out by the microcontroller 110.

The sensors 101, 102, 103 can therefore be configurable in an autonomous wake-up mode, in which the sensors 101, 102, 103 can wake up independently from a deep sleep mode on a cyclical basis. A sensor 101, 102, 103 configured in the wake-up mode can therefore be configured to wake up from the deep sleep with a predefined repetition rate without an explicit measurement command from the microcontroller 110, in order to carry out measurements autonomously and to return to deep sleep after a completed measurement.

If a measurement value of the sensor 101, 102, 103 configured in the wake-up mode, determined during a measurement, is above a predefined threshold value, the sensor 101, 102, 103 configured in the wake-up mode can store its last determined measurement value and send a wake-up pulse in at least one, preferably in both directions, along the daisy chain 130 so that the wake-up pulse is sent to the other sensors and/or to the microcontroller 110. The other sensors 101, 102, 103 can also store their measurement values current at this time. The sensors 101, 102, 103 can then remain awake until a readout command or a configuration command is received from the microcontroller 110.

To terminate the wake-up mode, the sensors 101, 102, 103 must be reconfigured, which is possible, for example, by a configuration command sent by the microcontroller 110. As an alternative or in addition to the previously described wake-up event, which is triggered by a sensor by exceeding/falling below a threshold value, the microcontroller 110 can also trigger a wake-up event itself, for example to force termination of the wake-up mode.

For example, the wake-up mode can be activated by selecting a wake-up frequency. The wake-up mode can start after the expiry of a certain waiting time T_{wake_up_delay} after the last stop bit (rising edge) sent by the microcontroller. In the wake-up mode, the sensors 101, 102, 103 can then carry out measurements independently with the selected wake-up frequency.

If at least one of the measurements is outside a configurable wake-up threshold value, a wake-up event is triggered. The single-wire data line 120 is pulled to low for this purpose by the respective sensor 101, 102, 103 for a predetermined duration T_{wake_up_pulse} and the corresponding sensor 101, 102, 103 stops its measurement and waits for a readout by the microcontroller 110.

If a sensor 101, 102, 103 detects a low signal level (e.g., triggered by another sensor) on the single-wire data line 120, it also stops its measurement and waits for the microcontroller 110 to read out its last measurement values.

The readout by the microcontroller 110 should preferably take place at the earliest after a predefined waiting time T_{wake_up_read}. Two conditions should be met before the Wake-Up mode can resume the measurement:
the respective sensor 101, 102, 103 has responded to a read-out command triggered by the microcontroller 110, and
the single-wire data line 120 remained at high level for the duration of T_{wake_up_delay}.

However, a read-out command should not be executed if a sensor 101, 102, 103 is in the wake-up mode and has not triggered a wake-up event.

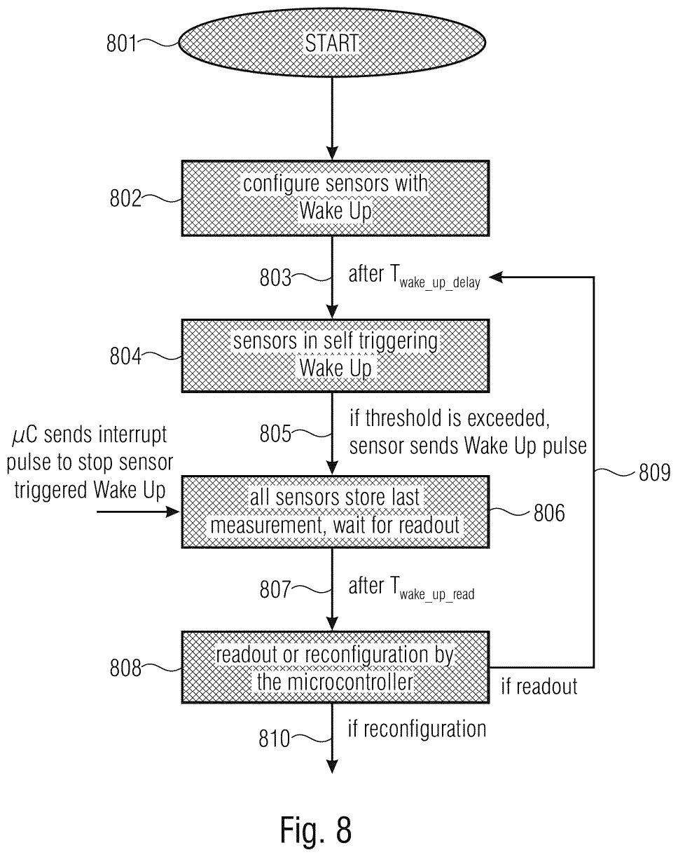

FIG. 8 shows a schematic flow diagram for a non-limiting example of the configurable wake-up mode. Block 801 marks the start of the processing sequence. In block 802, the sensors are configured in wake-up mode. After the waiting time T_{wake_up_delay} has elapsed (transition 803) has expired, the sensors 101, 102, 103 are in the wake-up mode (block 804), in which the sensors 101, 102, 103 autonomously wake up from deep sleep at freely configurable regular intervals and perform one or more measurements.

If one of the sensors 101, 102, 103 either falls below or exceeds a threshold value during a measurement (depending on the configuration), a wake-up pulse is sent from this sensor 101, 102, 103 (see transition 805). Otherwise, the sensors 101, 102, 103 return to deep sleep.

If a wake-up pulse has been sent from one of the sensors 101, 102, 103, the microcontroller 110 can finally send a n interrupt pulse to at least temporarily suspend the wake-up mode, and all sensors 101, 102, 103 can store their current measurement value at this time (transmitting the wake-up pulse or interrupt pulse) (see block 806).

After a waiting time T_{wake_up_read} has elapsed (transition 807), the microcontroller 110 can send a command (block 808) to read out the stored measurement data to the sensors 101, 102, 103, whereupon they send their measurement data to the microcontroller 101, 102, 103. Alternatively, the microcontroller 110 can send a configuration command to the sensors 101, 102, 103 to reconfigure them. It is also conceivable that the microcontroller 110 sends both commands, e.g., a command for reading out the sensors 101, 102, 103 and a configuration command for configuring the sensors 101, 102, 103 to the sensors 101, 102, 103 consecutively (in whatever order). In the case of a configuration command (transition 810), the sensors 101, 102, 103 are reconfigured. For example, this may terminate the wake-up mode.

In the case of a command to read out the measurement data (transition 809), by contrast, after sending their measurement data, and after the waiting time T_{wake_up_delay} has expired, the sensors 101, 102, 103 re-enter the wake-up mode, in which they go into deep sleep and wake up again from their deep-sleep phases at configurable intervals (see transition 803 and block 804).

As already mentioned, the intelligence of the DART sensor system 100 can be integrated into the hardware of the sensors 101, 102, 103. The following text describes the respective hardware states of the individual sensors 101, 102, 103 when they are in the wake-up mode. Reference is made here to the individual states 1 to 5, as previously described with reference to FIG. 7.

### Wake-Up Mode in the Line or Row Configuration

Firstly, the wake-up mode for sensors 101, 102, 103 in the line or row configuration according to FIGS. 1 to 3 is described. Subsequently, a description of the wake-up mode for sensors 101, 102, 103 in the ring configuration according to FIG. 4 is given.

In the line or row configuration, the microcontroller 110 can first switch its transmit pin 110_{Tx} to the tristate state in order to receive measurement data or a wake-up pulse from the sensors 101, 102, 103.

The sensors 101, 102, 103 which have been set to wake-up mode can be configured to first switch their respective first I/O pin 101_{IN}, 102_{IN}, 103_{IN} and second I/O pin 101_{OUT}, 102_{OUT}, 103_{OUT} to the pull-up state (state 1).

The following describes the behavior of sensors 101, 102, 103 in wake-up mode using the example of sensor 102. However, it goes without saying that the following description is valid for all sensors 101, 102, 103 that are configured in wake-up mode.

For a sensor 102 configured in wake-up mode, two scenarios are immediately conceivable. A first option provides that the sensor 102 detects a low pulse at its first or second I/O pin 102_{IN}, 102_{OUT}. That is, a wake-up pulse was sent from one of the adjacent sensors 101, 103 to the sensor 102. Depending on which adjacent sensor 101, 103, e.g., at which I/O pin 102_{IN}, 102_{OUT}, the sensor 102 has received the wake-up pulse, the signal is forwarded to the respective opposite side or to the other of the two I/O pins 102_{IN}, 102_{OUT}, by switching the other I/O pin 102_{IN}, 102_{OUT} to the push-pull low state (state 4) for the duration of the detected low pulse. This causes the low pulse to be sent from one side to the other. The sensor 102, which is in wake-up mode, can transmit the wake-up pulse in both directions. The sensor 102 then remains awake and waits for a read-out command from the microcontroller 110, to which the sensor 102 responds with the current measurement values.

According to such an implementation, a sensor 102 configured in wake-up mode can thus be configured to detect a low signal level originating from a directly adjacent sensor 101, 103 at its first or second I/O pin 102_{IN}, 102_{OUT}, the low signal level marking a wake-up pulse.

The sensor 102 configured in the wake-up mode can be configured, after detecting the wake-up pulse at its first or second I/O pin 102_{IN}, 102_{OUT}, to switch the corresponding other I/O pin 102_{IN}, 102_{OUT} to the push-pull low state (state 4) for the duration of the reception of the wake-up pulse in order to forward the wake-up pulse of the adjacent sensor 101, 103 in the opposite direction.

After forwarding the wake-up pulse, the sensor 102 configured in wake-up mode can remain awake and either wait for a read-out command of the microcontroller 110 to transmit its own current measurement data in response thereto, or wait for a configuration command from the microcontroller 110 to change its own configuration in response.

The second conceivable option provides that the sensor 102, configured in wake-up mode, measures a value itself that exceeds a predefined wake-up threshold value and then sends itself a wake-up pulse. In this case, the sensor 102 pulls both its first I/O pin 102_{IN} configured in the push-pull low state (state 4) and its second I/O pin 102_{OUT}, likewise configured in the push-pull low state (state 4), to low to send a wake-up pulse. The sensor 102, which is in wake-up mode, can send the wake-up pulse in both directions. The sensor 102 then remains awake and waits for the read-out command from the microcontroller 110.

In such an example implementation, the sensor 102 configured in the wake-up mode can thus be configured to store its last measurement value and send its own wake-up pulse along the daisy chain 130 if a measurement value of the sensor 102 obtained from a measurement in the wake-up mode exceeds a predefined threshold value, and to stay awake until a read-out command or a configuration command is received from the microcontroller 110.

The sensor 102 configured in the wake-up mode can also be configured to switch its first and second I/O pin 102_{IN}, 102_{OUT} to the push-pull low state (state 4) for the purpose of sending the wake-up pulse. Alternatively or in addition, the sensor 102 configured in the wake-up mode is configured to switch its first and second I/O pins 102_{IN}, 102_{OUT} back to the pull-up state (state 1) again after receiving the read-out command or the configuration command.

Another alternative is the case in which the microcontroller 110 sends a wake-up pulse to one or more of the sensors 101, 102, 103 configured in the wake-up mode in order to wake the sensors 101, 102, 103 from deep sleep. Here, also, the behavior of sensors 101, 102, 103 in wake-up mode is again described in the following using the example of sensor 102. However, it goes without saying that the following description is valid for all sensors 101, 102, 103 that are configured in wake-up mode.

According to such an example implementation, a sensor 102 configured in the wake-up mode can be configured to detect a low signal level originating from the microcontroller 110 at its first I/O pin 102_{IN}, wherein the low signal level signals a wake-up pulse for the sensor 102 configured in the wake-up mode.

The sensor 102 configured in the wake-up mode can transmit the wake-up pulse originating from the microcontroller 110 to the following sensors 103 in the daisy chain 130. For this purpose, the sensor 102 configured in the wake-up mode can be configured to switch its second I/O pin 102_{OUT} to the push-pull low state (state 4) for the duration of the reception of the wake-up pulse after detecting the wake-up pulse at its first I/O pin 102_{IN}, in order to forward the wake-up pulse coming from the direction of the microcontroller 110 in the opposite direction.

After detecting the wake-up pulse, the sensor 102 configured in wake-up mode can remain awake again to wait for a read-out command from the microcontroller 110 in order to transmit its own current measurement data in response thereto, or to wait for a configuration command from the microcontroller 110 to change its own configuration in response.

As mentioned earlier, a sensor 102 configure in wake-up mode can internally forward a wake-up pulse (originating from the microcontroller 110 or from another sensor 101, 103) between its two I/O pins 102_{IN}, 102_{OUT}. Instead of a digital data forwarding, which starts from an information pulse or the actual data transmission, the internal forwarding of the wake-up pulse can however also be realized with the aid of buffers or analog signal paths. Accordingly, a sensor 102 configured in the wake-up mode may, for example, have an integrated digital buffer circuit in order to forward the wake-up pulse in digital form between the pins 102_{IN}, 102_{OUT}. Alternatively or additionally, the sensor 102 configured in the wake-up mode may have an integrated impedance transformer to forward the measurement data in analog form between pins 102_{IN}, 102_{OUT}.

In summary, the innovative DART sensors 101, 102, 103 arranged in a line or row configuration according to FIGS. 1 to 3 can be set to an autonomous wake-up mode, wherein their first and second I/O pins 101_{IN}, 101_{OUT}, 102_{IN}, 102_{OUT}, 103_{IN}, 103_{OUT} should be able to assume at least the following states:
First I/O pin 101_{IN}, 102_{IN}, 103_{IN}: States 3 and 5
Second I/O pin 101_{OUT}, 102_{OUT}, 103_{OUT}: States 1, 2 and 4

### Wake-Up Mode in the Ring Configuration

Now that the wake-up mode for sensors 101, 102, 103 in the line or row configuration according to FIGS. 1 to 3 has been described, the wake-up mode for sensors 101, 102, 103 in the ring configuration according to FIG. 4 is discussed below.

In the ring configuration, the microcontroller 110 can first switch its transmit pin 110_{Tx} to an open drain state in order to receive measurement data or a wake-up pulse from the sensors 101, 102, 103.

The sensors 101, 102, 103 which have been set to wake-up mode can be configured to first switch their respective first I/O pin 101_{IN}, 102_{IN}, 103_{IN} and second I/O pin 101_{OUT}, 102_{OUT}, 103_{OUT} to the pull-up state (state 1).

The following describes the behavior of sensors 101, 102, 103 in wake-up mode using the example of sensor 102. However, it goes without saying that the following description is valid for all sensors 101, 102, 103 that are configured in wake-up mode.

For a sensor 102 configured in wake-up mode, two scenarios are immediately conceivable. A first option provides that the sensor 102 detects a low pulse at its first or second I/O pin 102^{IN}, 102_{OUT}. That is, a wake-up pulse was sent from one of the adjacent sensors 101, 103 to the sensor 102. Depending on which adjacent sensor 101, 103, e.g., at which I/O pin 102_{IN}, 102_{OUT}, the sensor 102 has received the wake-up pulse, the signal is forwarded to the respective opposite side or to the other of the two I/O pins 102_{IN}, 102_{OUT}.

For example, if the sensor 102 configured in wake-up mode receives a wake-up pulse at its first I/O pin 102_{IN} and forwards this to its second I/O pin 102_{OUT}, it thus switches its second I/O pin 102_{OUT} to the push-pull low state (state 4) for the duration of the detected low pulse. As a result the low pulse is forwarded from one side, e.g., from the first I/O pin 102_{IN}, to the other side, e.g., to the second I/O pin 102_{OUT}. The sensor 102 then remains awake and waits for a read-out command from the microcontroller 110, to which the sensor 102 responds with the current measurement values.

According to such an implementation, a sensor 102 configured in wake-up mode can be configured to detect, at its first I/O pin 102_{IN}, a low signal level originating from a sensor 101 directly adjacent in the direction of the transmit pin 110_{Tx} of the microcontroller 110, the low signal level marking a wake-up pulse.

The sensor 102 configured in the wake-up mode can be configured to switch its second I/O pin 102_{OUT} to the push-pull low state (state 4) for the duration of the reception of the wake-up pulse after detecting the wake-up pulse at its first I/O pin 102_{IN}, in order to forward the received wake-up pulse along the daisy chain 130 in the direction of the receive pin 110_{Rx} of the microcontroller 110. Thus, the wake-up pulse is forwarded to the sensors 103 connected downstream in the daisy chain 130.

After receiving and forwarding the wake-up pulse, the sensor 102 configured in wake-up mode can remain awake and either wait for a read-out command of the microcontroller 110 to transmit its own current measurement data in response thereto, or wait for a configuration command from the microcontroller 110 to change its own configuration in response.

After receiving the read-out command or the configuration command from the microcontroller 110, the sensor 102 configured in wake-up mode can switch its first and second I/O pins 102_{IN}, 102_{OUT} back to the pull-up state (state 1).

For example, if by contrast the sensor 102 configured in wake-up mode receives a wake-up pulse at its second I/O pin 102_{OUT} and forwards this to its first I/O pin 102_{IN}, it thus switches its first I/O pin 102_{IN} to the pull-down state (state 5) for the duration of the detected low pulse. As a result the low pulse is forwarded from one side, e.g., from the second I/O pin 102_{OUT}, to the other side, e.g., to the first I/O pin 102_{IN}. The sensor 102 then remains awake and waits for a read-out command from the microcontroller 110, to which the sensor 102 responds with the current measurement values.

According to such an implementation, a sensor 102 configured in the wake-up mode can thus be configured to detect, at its second I/O pin 102_{OUT}, a low signal level originating from a sensor 103 directly adjacent in the direction of the receive pin 110RX of the microcontroller 110, the low signal level marking a wake-up pulse.

The sensor 102 configured in the wake-up mode can be configured to switch its first I/O pin 102_{IN} to the pull-down state (state 5) for the duration of the reception of the wake-up pulse after detecting the wake-up pulse at its second I/O pin 102_{OUT}, in order to forward the received wake-up pulse along the daisy chain 130 in the direction of the transmit pin 110_{Tx} of the microcontroller 110. Thus, the wake-up pulse is forwarded to the sensors 101 connected upstream in the daisy chain 130.

After receiving and forwarding the wake-up pulse, the sensor 102 configured in wake-up mode can remain awake and either wait for a read-out command of the microcontroller 110 to transmit its own current measurement data in response thereto, or wait for a configuration command from the microcontroller 110 to change its own configuration in response.

After receiving the read-out command or the configuration command from the microcontroller 110, the sensor 102 configured in wake-up mode can switch its first and second I/O pins 102_{IN}, 102_{OUT} back to the pull-up state (state 1).

The second conceivable option provides that the sensor 102 itself, configured in the wake-up mode, measures a value that exceeds a predefined wake-up threshold value and the sensor 102 itself then sends a wake-up pulse to the microcontroller 110. In this case, the sensor 102 switches its first I/O pin 102_{IN} to the pull-down state (state 5) and its second I/O pin 102_{OUT} to the push-pull low state (state 4) to send a wake-up pulse. The sensor 102 then remains awake and waits for the read-out command from the microcontroller 110.

In such an example implementation, the sensor 102 configured in the wake-up mode can thus be configured to store its last measurement value and send its own wake-up pulse along the daisy chain 130 if a measurement value of the sensor 102 obtained from a measurement in the wake-up mode exceeds a predefined threshold value, and to stay awake until a read-out command or a configuration command is received from the microcontroller 110.

After receiving the read-out command or the configuration command from the microcontroller 110, the sensor 102 configured in wake-up mode can switch its first and second I/O pins 102_{IN}, 102_{OUT} back to the pull-up state (state 1).

Another alternative is the case in which the microcontroller 110 sends a wake-up pulse to one or more of the sensors 101, 102, 103 configured in the wake-up mode in order to wake the sensors 101, 102, 103 from deep sleep. Here, also, the behavior of sensors 101, 102, 103 in wake-up mode is again described in the following using the example of sensor 102.

However, it goes without saying that the following description is valid for all sensors 101, 102, 103 that are configured in wake-up mode.

According to such an example implementation, a sensor 102 configured in the wake-up mode can be configured to detect a low signal level originating from the microcontroller 110 at its first I/O pin 102_{IN}, wherein the low signal level signals a wake-up pulse for the sensor 102 configured in the wake-up mode.

The sensor 102, configured in the wake-up mode, can forward the wake-up pulse originating from the transmit pin 110_{Tx} of the microcontroller 110 along the daisy chain 130 in the direction of the receive pin 110_{Rx} of the microcontroller 110, which means that the wake-up pulse is also transmitted to the sensors 103 connected downstream in the daisy chain 130. For this purpose, the sensor 102 situated in the wake-up mode can be configured to switch its second I/O pin 102_{OUT} to the push-pull low state (state 4) for the duration of the reception of the wake-up pulse after detecting the wake-up pulse at its first I/O pin 102_{IN}, in order to forward the wake-up pulse coming from the transmit pin 110_{Tx} of the microcontroller 110 in the opposite direction, e.g., in the direction of the receive pin 110_{Rx} of the microcontroller 110.

After detecting the wake-up pulse, the sensor 102 configured in wake-up mode can remain awake again to wait for a read-out command from the microcontroller 110 in order to transmit its own current measurement data in response thereto, or to wait for a configuration command from the microcontroller 110 to change its own configuration in response.

After receiving the read-out command or the configuration command from the microcontroller 110, the sensor 102 configured in wake-up mode can switch its first and second I/O pins 102_{IN}, 102_{OUT} back to the pull-up state (state 1).

As mentioned earlier, a sensor 102 configure in wake-up mode can internally forward a wake-up pulse (originating from the microcontroller 110 or from another sensor 101, 103) between its two I/O pins 102_{IN}, 102_{OUT}. Instead of a digital data forwarding, which starts from an information pulse or the actual data transmission, the internal forwarding of the wake-up pulse can however also be realized with the aid of buffers or analog signal paths. Accordingly, a sensor 102 configured in the wake-up mode may, for example, have an integrated digital buffer circuit in order to forward the wake-up pulse in digital form between the pins 102_{IN}, 102_{OUT}. Alternatively or additionally, the sensor 102 configured in the wake-up mode may have an integrated impedance transformer to forward the measurement data in analog form between pins 102_{IN}, 102_{OUT}.

In summary, the innovative DART sensors 101, 102, 103 arranged in a ring configuration according to FIG. 4 can thus be set to an autonomous wake-up mode, wherein their first and second I/O pins 101_{IN}, 101_{OUT}, 102_{IN}, 102_{OUT}, 103_{IN}, 103_{OUT} should be able to assume at least the following states:
First I/O pin 101_{IN}, 102_{IN}, 103_{IN}: States 3 and 5
Second I/O pin 101_{OUT}, 102_{OUT}, 103_{OUT}: States 1, 2 and 4

### Low-Power Mode

In addition to the wake-up mode just discussed, the innovative DART sensors 101, 102, 103 can alternatively or additionally also be configured in a low-power mode. The low-power mode described in more detail below can be activated both for line and row configurations according to FIGS. 1 to 3 and for ring configurations according to FIG. 4.

While a sensor 102 in wake-up mode autonomously wakes up, measures and informs the microcontroller 110 on a cyclical basis, a sensor 101, 102, 103 in the low-power mode does not wake up by itself, but only when it receives an explicit wake signal from the microcontroller 110.

When the low-power mode is activated, the sensor 101, 102, 103 configured in the low-power mode transfers to deep sleep after a measurement cycle. The current sensor configuration is stored during the deep sleep. In order to wake the sensor 101, 102, 103 in low-power mode from deep sleep, the microcontroller 110 can send a communication enable pulse to the sensor 101, 102, 103 configured in low-power mode. The communication enable pulse can be followed by a freely configurable delay time (e.g., 8 μs) before the microcontroller 110 sends the next command.

According to such an implementation, the innovative DART sensors 101, 102, 103 can thus be configurable in a low-power mode, in which the sensors 101, 102, 103 can be woken from a deep sleep mode by the microcontroller 110.

A sensor 101, 102, 103 configured in the low-power mode may in this case be configured to transmit the measurement value determined in the process to the microcontroller 110 after triggering a measurement and then to go into a deep sleep, and to wake up again from deep sleep only in response to receiving a wake-up command from the microcontroller 110 in order to perform a new action.

### Overview of the States of the DART Sensors

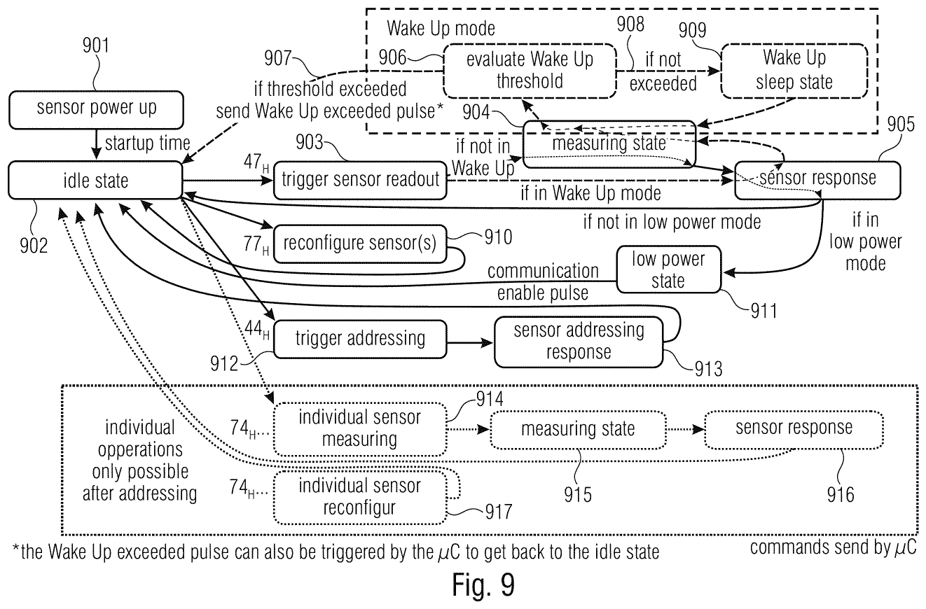

FIG. 9 summarizes an overview of possible states of the DART sensors 101, 102, 103 in the form of a state diagram.

After switching on (block 901) the DART sensors 101, 102, 103, the DART sensors 101, 102, 103 can first perform a reset and independently reset themselves to a default value. The DART sensors 101, 102, 103 are then in the idle state (block 902).

From there, sensors 101, 102, 103 can receive a measurement command (block 903) from the microcontroller 110. If the sensors 101, 102, 103 are not in wake-up mode, they transfer to the measuring state (block 904). They then send their readings (block 905) to the microcontroller 110 and, if they are not in low-power mode, return directly to the idle mode (block 902). If they are in low-power mode, on the other hand, the sensors 101, 102, 103 transfer to a low-power state (block 911) after sending the readings (block 905) and only return to the idle state (block 902) after receiving a communication enable pulse from the microcontroller 110.

If the sensors 101, 102, 103 are in the wake-up mode when receiving the measurement command (block 903), they cyclically check whether they have measured a value that falls below or exceeds a predefined threshold value (block 906). In this case, they send a wake-up pulse (transition 907) and return to the idle mode (block 902). Otherwise (transition 908), the sensors 101, 102, 103 return to their cyclic sleep mode (block 909). The wake-up pulse can also be sent by the microcontroller 110 to put the sensors 101, 102, 103 back into the idle state (block 902).

Alternatively, the sensors 101, 102, 103 can receive a configuration command (block 910) from the microcontroller 110. If the sensors 101, 102, 103 are not in the wake-up mode, then the sensors 101, 102, 103 configure themselves according to the values sent by the microcontroller 110 and return to the idle mode (block 902).

If on the other hand the sensors 101, 102, 103 are in the wake-up mode when receiving the configuration command (block 910), they cyclically check whether they have measured a value that falls below or exceeds a predefined threshold value (block 906). In this case, they send a wake-up pulse (transition 907) and return to the idle mode (block 902). Otherwise (transition 908), the sensors 101, 102, 103 return to their cyclic sleep mode (block 909). The wake-up pulse can also be sent by the microcontroller 110 to put the sensors 101, 102, 103 back into the idle state (block 902).

Furthermore, the sensors 101, 102, 103 can receive an auto-addressing command (block 912) from the microcontroller 110. In response, the sensors 101, 102, 103 independently assign themselves an individual address (block 913) and send it to the microcontroller 110. They then return to idle mode (block 902).

If the sensors 101, 102, 103 have addressed themselves, the sensors 101, 102, 103 can be individually addressed by the microcontroller 110 and, for example, receive an individual measurement command (block 914) from the microcontroller 110. The individually addressed sensor is then placed in the measuring state (block 915), where it triggers one or more measurements. The sensor then sends the measurement results obtained to the microcontroller 110 (block 916). The sensor then returns to the idle state (block 902).

Alternatively or in addition to the individual measurement command just discussed, the sensors 101, 102, 103 can receive an individual configuration command (block 917) from the microcontroller 110 after the auto-addressing has been carried out. The individually addressed sensor then configures itself with the values transmitted by the microcontroller 110 and then returns to the idle state (block 902).

### Use Cases

In order to explain the DART concept in more detail using examples, six different use case scenarios are shown in the following, which are intended to explain how the communication between the microcontroller 110 and the DART sensors 101, 102, 103 proceeds.

### Use Case 1: A Single DART Sensor

In this use case scenario, a single sensor is operated, which communicates with the microcontroller via the DART interface. The sensor is configured to have its maximum measuring range without an additional range offset. This use case describes the default configuration of the sensor and therefore no reconfiguration is required.
a) No configuration is required after the sensor is turned on, as the default reset values of the sensor meet the required conditions in this use case.
b) A new measurement is triggered by the microcontroller by setting the TX pin to PUSH PULL and sending a measurement command (e.g., 0x47).
c) The measurement of the sensor is triggered by the rising edge of the stop bit.
d) The microcontroller switches its TX pin to the TRISTATE state
e) The sensor transmits its measurement values after the measurement has been completed
f) Once the readings have been received, the sensor can be reconfigured or a new measurement according to step b.) can be triggered.

### Use Case 2: Multiple Dart Sensors With Identical Configuration

In this use case scenario, three sensors are operated via the DART interface. All sensors are configured in the same way. The configuration can be freely selected. All sensors can perform a measurement simultaneously in response to a measurement command from the microcontroller.
a) After the sensors are switched on, the microcontroller can send the desired configuration to all sensors by setting its TX pin to PUSH PULL
b) A new measurement is triggered by the microcontroller by setting the TX pin to PUSH PULL and sending a measurement command (e.g., 0x47).
c) The sensors perform a measurement that is triggered by the rising edge of the stop bit.
d) The microcontroller switches its TX pin to the TRISTATE state
e) The sensors transmit their respective measurement values to the microcontroller
f) Since there are three sensors on the bus, the sensors respond in the response sequence described above, depending on their position on the bus. The first sensor, which is directly connected to the microcontroller, sends first, followed by the sensor positioned after the first sensor, and so on.
g) Only after all sensor data has been received can the sensor be reconfigured or a new measurement according to step b can be triggered.

### Use Case 3: Multiple Dart Sensors With Individual Configurations and Joint Readout of All Sensors

Before the sensors can be accessed individually, either for reconfiguration or for readout, they must first obtain an individual address. The auto-addressing command described above triggers all sensors to assign themselves an address consecutively, depending on their position on the bus. Only after the addresses have been assigned can the individual configuration of a sensor take place and individual sensor measurements be triggered.
a) After the sensors are switched on, the microcontroller can first send a desired default configuration to all sensors by setting its TX pin to PUSH PULL. As a result, all sensors are initially configured in the same way.
b) In order to enable individual operations, the microcontroller first initiates the individual sensor addressing by sending the auto-addressing command (e.g., 0x44) to the sensors and waiting until the auto-addressing is completed.
c) For example, the second sensor in the daisy chain can be reconfigured with a configuration sent by the microcontroller, by the microcontroller switching its TX pin to PUSH PULL and sending a DART data frame with the desired configuration to that same sensor.
d) The microcontroller can trigger a new measurement by setting its TX pin to PUSH PULL and sending the broadcast measurement command (e.g., 0x47) to all sensors.
e) The sensors perform a measurement triggered by the rising edge of the stop bit.
f) The microcontroller switches its TX pin to the TRISTATE state.
g) The sensors each send their measurement data to the microcontroller after their measurement has been completed.
h) The sensors respond with their measurement values in the response sequence described above according to their position on the bus. The first sensor directly connected to the microcontroller is the first to send its measurement data to the microcontroller, followed by the sensor positioned after it, and so on.
i) Only after all measurement data has been received from the microcontroller can the sensor be reconfigured or a new measurement according to step d) can be triggered.

### Use Case 4: Multiple DART Sensors and Individual Readout of Individual Sensors

Before the sensors can be accessed individually, either for reconfiguration or for readout, they must first obtain an individual address. The auto-addressing command described above triggers all sensors to assign themselves an address consecutively, depending on their position on the bus. Only after the addresses have been assigned can the individual configuration of a sensor take place and individual sensor measurements be triggered.

In this use case scenario, three sensors are operated via the DART interface. Not all sensors are configured after switching on, but are used in the default configuration. In this example, an individual single measurement is only triggered for the first sensor that is directly connected to the microcontroller.
a) After switching on the sensors, no individual configuration of the sensors is required, as in this example the default reset values of the sensors are used.
b) In order to enable individual operations, the microcontroller first initiates the individual sensor addressing by sending the auto-addressing command (e.g., 0x44) to the sensors and waiting until the auto-addressing is completed.
c) The first sensor is individually addressed by the microcontroller, by the microcontroller setting its TX pin to PUSH PULL and sending an individual measurement command (e.g., 0x74) followed by the address of the sensor
d) The measurement of the sensor is triggered by the rising edge of the stop bit.
e) The microcontroller switches its TX pin to the TRISTATE state.
f) The sensor transmits its measurement data to the microcontroller after the measurement has been completed.
g) Of the three sensors on the bus, only the individually addressed first sensor responds by transmitting its measurement data.
h) Only after the measurement data has been fully received from the microcontroller can the sensor be reconfigured or a new single measurement according to step c.) be triggered.

### Use Case 5: Multiple Dart Sensors in Low-power Mode (Communication Enable Pulse Required)

In this use case scenario, multiple DART sensors are operated in power-saving mode. In power saving mode, the microcontroller must send a “communication enable pulse” to terminate the deep sleep of the sensors, and the microcontroller must then wait for a predefined waiting time to elapse before starting a new communication with the sensors.

A total of N sensors are involved in this use case scenario. All sensors are configured in the same way. The sensors go into deep sleep after a measurement cycle.
a) After switching on the sensors, the microcontroller sends a broadcast configuration command (e.g., 0x77) with the same configuration to all sensors by the microcontroller setting its TX pin to PUSH PULL and sending a DART data frame with the corresponding configuration to the sensors.
b) After the sensors are configured, the microcontroller triggers a new measurement by setting its TX pin to PUSH PULL and sending a broadcast measurement command (e.g., 0x47) to all sensors.
c) The sensors perform a measurement triggered by the rising edge of the stop bit.
d) To receive the measurement data, the microcontroller switches its TX pin to the TRISTATE state.
e) The sensors send their measurement data to the microcontroller after the measurement has been completed.
f) The first sensor directly connected to the microcontroller first sends its measurement data in the response sequence described above, followed by the sensor that comes after it, and so on.
g) After the sensors have transmitted their measurement data and a timeout has expired, the sensors transfer to deep sleep.
h) Only after the microcontroller has received all the measurement data and the sensors have been transferred into deep sleep can the microcontroller trigger a new action.
i) Before a new action, however, a communication enable pulse must first be sent. After a waiting time, the sensors can then be reconfigured or a new measurement according to step b.) can be triggered.

### Use Case 6: Multiple DART Sensors in Wake-Up Mode

In this use case scenario, multiple sensors are operated in the wake-up mode. The sensors perform regular measurements without the control of the microcontroller. The sensors send a wake-up signal to the microcontroller when predefined threshold values are exceeded.

In this example, N sensors are operated via the DART interface. All sensors are configured in the same way. A threshold measurement value (or measuring range) is set and a cyclic wake-up time is set, so that the sensors wake up every 0.8 seconds, for example. If the measured signal is outside the threshold measurement range, a wake-up signal is sent to the microcontroller and the sensors remain awake, store their last measurement results and wait for the microcontroller to read out the stored measurement values.
a) After switching on the sensors, the microcontroller sends a broadcast configuration command (e.g., 0x77) with the same configuration to all sensors by the microcontroller setting its TX pin to PUSH PULL and sending a DART data frame with the corresponding configuration to the sensors.
b) The sensors transfer to the wake-up mode and perform cyclic measurements independently.
c) The microcontroller switches its TX pin to the TRISTATE state.
d) If a wake-up event occurs, e.g., if a currently measured measurement value of a sensor exceeds or falls below the preset threshold value, this one sensor sends a wake-up pulse, which propagates along the daisy chain via the other sensors to the microcontroller.
e) All sensors in the daisy chain store their last measurement value and wait for a read-out command from the microcontroller.
f) The readout of the measurement values is triggered by the microcontroller by setting its TX pin to PUSH PULL and sending a broadcast measurement command (e.g., 0x47) to all sensors.
g) The microcontroller sets its TX pin to TRISTATE.
h) The sensors transmit their last stored measurement value according to the response sequence described above, starting with the first sensor which is directly connected to the microcontroller.
i) After the data transfer, the sensors return directly to the wake-up mode as described in step b).
j) To terminate the wake-up mode, the sensors must be reconfigured, which is possible, for example, in step f). The microcontroller can also trigger a wake-up event itself, as described in step d), to force the termination of the wake-up mode.

### Summary and Benefits

The concept presented here (DART: Daisy Chain Asynchronous Transmitter and Receiver) is compatible with the UART standard (UART: Universal Asynchronous Transmitter and Receiver). A DART data frame 200 can be based on UART data frames (one start bit 0B, eight data bits LSB first, one stop bit 1B), wherein even more data bits are possible with DART. DART also requires no initialization and allows faster bus speeds of up to 8 MBd and in some configurations even up to 40 MBd.

DART is therefore an extension of the UART standard, which allows UART to be converted into a multi-sensor bus without having to address the sensors for this purpose. DART is more efficient than other approaches because it can use active push-pull states. This allows significantly faster communication speeds and provides an elegant solution to ensure that the response sequence of the sensors in the daisy chain, e.g., on the bus, is guaranteed. In DART, this requires fewer wires than in other bus systems.

The DART sensors 101, 102, 103 can be individually configurable to allow very good adaptation to different applications. The DART sensors 101, 102, 103 use the innovative concept presented here-Daisy Chain Asynchronous Receiver Transmitter (DART)-as a communication interface with the microcontroller 110.

The innovative DART interface can have the following main functions:
Configuration of the sensors 101, 102, 103
Triggering a measurement of the sensors 101, 102, 103
Transferring measurement data from the sensors 101, 102, 103 to the microcontroller 110

Even if all channels are disabled, daisy chain communication is possible The innovative DART interface can be UART-based and can have the following settings, for example:
Baud rate: 100 kBd to 40 MBd
Start bits: one start bit (0B)
Data: eight bits
Parity: None
Stop bits: one stop bit (1B)
Significant bit: the least significant bit (LSB) is sent first

The microcontroller 110 can vary the baud rate if necessary. The DART interface can be accessed in any power supply mode after power-up. The innovative DART interface can be compatible with UART in open-drain mode or in push-pull tristate mode.

To ensure data integrity, the microcontroller 110 can wait until all responses from the sensors 101, 102, 103 have been received before triggering a new measurement/reading or configuration. In the event of a communication failure, a restart can take place after power-off. After the restart, the microcontroller 110 can reconfigure the sensors 101, 102, 103.

With DART, the sensors 101, 102, 103 can be operated in a daisy chain 130, wherein up to 128 sensors are possible on one bus. This provides the possibility for multi-sensor/array measurements. A measurement can be triggered synchronously on all sensors 101, 102, 103. Individual configurations and readouts on the bus nodes are also possible. To reduce system power consumption, the number of response bytes of the sensors 101, 102, 103 can be configured. In this way, the required data accuracy can be adjusted and unnecessary status bits can be avoided.

It should be pointed out that the description and the drawings only illustrate the principles of the proposed methods and devices. A person skilled in the art will be capable of implementing different arrangements which, although they are not expressly described or shown here, embody the principles of the implementation and are contained within the scope thereof. In addition, all examples and implementations outlined in the present document are intended fundamentally and expressly for explanatory purposes only, in order to help the reader understand the principles of the proposed processes and devices. In addition, all statements in this document that describe principles, aspects and implementations of the implementation and specific examples thereof are also intended to encompass their equivalents.

1. A sensor system with asynchronous data transmission, the sensor system comprising:
at least two sensors, each sensor having a first I/O pin and a second I/O pin,
a microcontroller with a transmit pin and a receive pin, and
a single-wire data line, by means of which the microcontroller is configured to communicate with the at least two sensors via an asynchronous data protocol,
wherein the single-wire data line runs between the transmit pin and the receive pin of the microcontroller, and
wherein the at least two sensors are arranged in a daisy chain and are integrated into the single-wire data line sequentially.

2-6. (canceled)

7. The sensor system as claimed in claim 1,
wherein the transmit pin of the microcontroller has a push-pull configuration, and
wherein the receive pin of the microcontroller is configured as an open-drain input with an integrated pull-up resistor.

8. The sensor system as claimed in claim 7,
wherein the sensor system is configured to enable unidirectional data communication between the microcontroller and the at least two sensors using the single-wire data line,
wherein a first sensor in the daisy chain is connected in series with the transmit pin of the microcontroller, and wherein a last sensor in the daisy chain is connected in series with the receive pin of the microcontroller.

9. A sensor system with asynchronous data transmission, the sensor system comprising:
at least two sensors, each sensor having a first I/O pin and a second I/O pin,
a microcontroller with a combined transmit and receive pin that is configured to be internally switched between a transmit state and a receive state,
a single-wire data line by means of which the microcontroller is configured to communicate with the at least two sensors via an asynchronous data protocol,
wherein the at least two sensors are arranged in a daisy chain and are integrated into the single-wire data line sequentially, and
wherein the single-wire data line runs between the combined transmit and receive pin of the microcontroller and the at least two sensors included in the daisy chain.

10. The sensor system as claimed in claim 9,
wherein the sensor system is configured to enable bi-directional data communication between the microcontroller and the at least two sensors using the single-wire data line,
wherein a first sensor in the daisy chain is connected to the combined transmit and receive pin of the microcontroller, and
wherein one of the first and the second I/O pins of a last sensor in the daisy chain is configured as an uncontacted high-impedance floating output.

11. The sensor system as claimed in claim 1,
wherein the at least two sensors arranged in the daisy chain are configured, on a hardware side, to each occupy at least one of plurality of states at both their respective first I/O pin and at their respective second I/O pin, the plurality of states including:
a pull-up state, in which the respective I/O pin is pulled to a high level using a resistor, and in which the respective I/O pin is only capable of being pulled to a low level using an external ground connection,
a push-pull high state, in which the respective I/O pin is pulled to the high level in order to also pull a connected component to the high level, and
a push-pull low state, in which the respective I/O pin is pulled to the low level in order to also pull a connected component to the low level.

12. The sensor system as claimed in claim 11,
wherein the microcontroller is configured to send a measurement command to the at least two sensors arranged in the daisy chain via the single-wire data line in order to signal to the at least two sensors to carry out a measurement, and
wherein the at least two sensors are configured to perform a measurement in response to the measurement command, and measurement data received from the measurement is transmitted along the daisy chain to the microcontroller in sequence in a predetermined response sequence.

13. The sensor system as claimed in claim 12,
wherein the at least two sensors are configured to transmit their measurement data to the microcontroller in ascending response sequence, starting with a sensor positioned closest to the microcontroller through to a sensor positioned furthest from the microcontroller.

14. The sensor system as claimed in claim 12,
wherein the at least two sensors are configured to switch their first I/O pin to the pull-up state after receiving the measurement command and to switch their second I/O pin to the push-pull low state,
wherein a sensor of the at least two sensors arranged in the daisy chain at position X is configured to send its measurement data in a direction of the microcontroller only when the sensor receives a high signal level at its first I/O pin, the high signal level coming from either a sensor of the at least two sensors that is directly adjacent to the sensor arranged at position X in the direction of the microcontroller or from the microcontroller, and
wherein the sensor arranged at position X is configured to toggle its first I/O pin between the push-pull high state and the push-pull low state to transmit its measurement data, while its second I/O pin remains in the push-pull low state.

15. The sensor system as claimed in claim 14, wherein the sensor arranged at position X is configured to switch both its first I/O pin and its second I/O pin into the pull-up state after a completed transmission of its measurement data in order to signal to a sensor of the at least two sensors that is directly adjacent to the sensor arranged at position X in an opposite direction of the microcontroller, using a high signal level that it is now the turn of the sensor directly adjacent to the sensor arranged at position X in the opposite direction of the microcontroller to send its measurement data.

16-28. (canceled)

29. The sensor system as claimed in claim 7,
wherein the at least two sensors arranged in the daisy chain are configured, on a hardware side, to each occupy at least one of plurality of states at both their respective first I/O pin and at their respective second, the plurality of states including:
a pull-up state, in which the respective I/O pin is pulled to high level using a pull-up resistor and can only be pulled to low level using an external ground connection,
a push-pull high state, in which the respective I/O pin is pulled to high level in order to also pull a connected component to high level,
a tristate state in which the respective I/O pin is configured as an uncontacted high-impedance floating terminal to occupy a same level as a connected component,
a push-pull low state, in which the respective I/O pin is pulled to low level in order to also pull a connected component to low level, and
a pull-down state, in which the respective I/O pin is pulled to low level using a pull-down resistor and can only be pulled to low level using an external operating voltage connection.

30. The sensor system as claimed in claim 29,
wherein the microcontroller is configured to send a measurement command to the at least two sensors arranged in the daisy chain via the single-wire data line in order to signal to the at least two sensors to perform a measurement, and
wherein the at least two sensors are configured to perform measurements in response to the measurement command, and measurement data received from the measurements is transmitted along the daisy chain to the microcontroller in sequence in a predetermined response sequence.

31. The sensor system as claimed in claim 30,
wherein the at least two sensors are configured to transmit their measurement data to the microcontroller in descending response order, starting with a sensor of the at least two sensors that is positioned closest to the receive pin of the microcontroller, with respect to a connection sequence in the daisy chain, through to a sensor of the at least two sensors that is positioned closest to the transmit pin of the microcontroller.

32. The sensor system as claimed in claim 30,
wherein the at least two sensors arranged in the daisy chain are configured to switch their first I/O pin to the pull-down state after receiving the measurement command and to switch their second I/O pin to the pull-up state, the pull-up resistor being larger than the pull-down resistor to pull a value generated in a resistor divider to a defined signal level.

33-39. (canceled)

40. The sensor system as claimed in claim 29,
wherein the at least two sensors are configurable in an autonomous wake-up mode, in which the at least two sensors autonomously wake up from a deep sleep mode, and
wherein a sensor configurable in the autonomous wake-up mode is configured to:
wake up from the deep sleep node with a predefined repetition rate without an explicit measurement command of the microcontroller, in order to carry out measurements autonomously and to return to the deep sleep mode after a completed measurement.

41-54. (canceled)

55. The sensor system as claimed in claim 9,
wherein a data frame is compatible with a universal asynchronous receiver and transmitter protocol.

56-66. (canceled)
